(19) United States
(12) Patent Application Publication
(10) Pub. No.: US 2005/0143927 A1
(43) Pub. Date: Jun. 30, 2005

(54) Method for estimating or predicting the anti-tumor activity of a compound and for estimating or predicting the tumor growth in mammals

(75) Inventors: Cristiano Cammia, Broni (IT); Giuseppe DeNicolao, Milano (IT); Italo Poggesi, Arno (IT); Maurizio Rocchetti, Rho (IT)

Correspondence Address: SCULLY SCOTT MURPHY & PRESSER, PC, 400 GARDEN CITY PLAZA, SUITE 300, GARDEN CITY, NY, 11530, US

(73) Assignees: Pharmacia Italia S.p.A., Milan (IT); Universita Degli Studi Di Pavia, Pavia (IT)

(21) Appl. No.: 10/941,459

(22) Filed: Sep. 15, 2004

(30) Foreign Application Priority Data
Mar. 15, 2002 (EP) 02425157.1
Mar. 14, 2003 (WO) PCT/EP03/02689

(51) Int. Cl. G06F 19/00

(52) U.S. Cl. 702/19

(57) ABSTRACT

The present invention relates to a method for estimating or predicting anti-tumor activity of a compound and for estimating or predicting the tumor growth in mammals; the estimation comprises a) measuring the tumor weight in time; b) measuring the concentration of the compound in time; c) calculating kinetic parameters of the tumor growth: -a parameter (L₀), representative of the portion of tumor cells present at the instant t₀=0 that succeeds in taking root and in starting tumor cells proliferation in the mammals; -an index (λ₀) of the production rate of tumor cells during an exponential phase of tumor growth; -an index (λ₁) of tumor cells mass produced in the time unit during a linear phase of the tumor growth; and pharmacodynamic parameters: -an index (K₁) of tumor cells death rate; -an index (K₂) of the potency of the compound; and d) calculating tumor growth curves.

### CROSS REFERENCE TO RELATED APPLICATIONS

This application is based upon and claims the benefit of priority from European Patent Application No. 02425157.1 filed on Mar. 15, 2002, the entire contents which is expressly incorporated herein by its reference.

### FIELD OF THE INVENTION

The present invention relates to a method for estimating or predicting the anti-tumor activity of a compound and for estimating or predicting the tumor growth in mammals.

### BACKGROUND OF THE INVENTION

The in vivo evaluation of the anti-tumor effect of a drug is a fundamental step in the development and evaluation of anti-tumor drugs. In some experiments, tumor cells from immortalized cell lines are inoculated in animals, for example in nude mice, commonly randomised between control and treated animals; in other experiments, tumors grow spontaneously in animals. When a minimal standardised tumor mass is reached, either the vehicle or the active drug treatment are given to control and treatment animals, respectively. The tumor volume is then measured at different times throughout the experiment. It is known to define the effect of the drug on the tumor growth by calculating the inhibition of the tumor growth compared to that observed in control animals at a defined time after the end of the treatment, or by underlining the increase in survival time, expressed as the increase of time required to achieve a certain tumor mass.

This approach is known for defining the most efficient drug candidate within a series of drugs and/or for testing different dosage regimens.

To describe the dynamics of the tumor growth, a number of mathematical models is known; yet, the equations used are either purely empiric and comprise parameters without a biological meaning, or are so complex that it is impossible to derive reasonable estimates from the experimental data.

The use of empirical mathematical equations (e.g. sigmoidal functions such as logistic, Verhulst, Gomperts, von Bertalanffy) is known in order to describe the growth curve of macroscopic variables such as volume, mass or size of cellular population (e.g., Maru\check{s}iae, M.; Bajzer, \check{Z}. Generalized two-parameter equation of growth. J Math Anal Appl 1993, 179, 446-461; Bajzer, \check{Z}.; Maru\check{s}iae, M.; Vuk-Pavlociae, S. Conceptual frameworks for mathematical modeling of tumor growth dynamics. Mathl Comput Modelling. 1996, 23, 31-46); their aim is to predict the tumor growth even without an in-depth mechanistic description of the underlying physiological processes, so that they are typically defined using parameters with limited biological relevancy and they have little predictive power.

Most often, the growth of biological systems, from a phenomenological and macroscopic point of view, is described by empirical curves with sigmoidal profile. In the in vivo tumor growth kinetics, the tumor mass is treated as a population of homogeneous cells in which the fluctuations and the demographic structure have negligible effects on the macroscopic dimensions of the tumor. The imposition of a sigmoidal profile to the tumor mass finds its own theoretical base in the general observation that the observed solid tumors slow down their own growth, as soon as they become greater, up to reach an asymptotic value (plateau). Denoting the weight of the tumor with W(t), a possible mathematical paradigm for empirical models is furnished by the following autonomous differential equation with initial value W₀:

$$\frac{ⅆ W ( t )}{ⅆ t} = G ( W ( t ) ) - D ( W ( t ) ) \\ W ( 0 ) = {W}_{0} \qquad ( 5.1 )$$

where G(W(t))>0 represents the effective rate of growth, while D(W(t))>0 represents the degradation one. Both functions are differentiable increasing functions, coinciding in correspondence of the plateau \overline{W} and such that G(W₀)>D(W₀). The various models heretofore applied are described by equations (von Bertalanffy, Logistic Growth, Gompertz equation, etc.) that are particular cases of the (5.1) on the base of different choices of the functions G(W(t)) and D(W(t)) (Bajzer, \check{Z}.; Maru\check{s}iae, M.; Vuk-Pavlociae, S. Conceptual frameworks for mathematical modeling of tumor growth dynamics. Mathl Comput Modelling. 1996, 23, 31-46). Despite the similar mathematical structure, only the model described by Gompertz succeeds in adequately describing a large range of experimental data, although the interpretation of its biological meaning still appears difficult (G. G. Steel, “Growth kinetics of tumours”, Clarendon Press, 1977).

Functional models, conversely to the empiric approach, are based on a set of assumptions about biological growth from a mechanistic, physiologically based point of view, involving cell-cycle kinetics and biochemical processes such as those related to angiogenesis and/or immunological events (e.g. Bajzer et al., 1996, ditto; Bellomo, N.; Preziosi, L. Modeling and mathematical problems related to tumor evolution and its interaction with the immune system. Mathl. Comput. Modelling 2000, 32, 413-452). Such models usually represent the cell population in its heterogeneity; in the simplest case, the whole population consists of two subpopulations only: the proliferating and the quiescent one. More complex models describe the cell population as age structured and take into account more than two subpopulations related to specific phases of the mitotic cell cycle. Functional models, based on biological principles, are generally complex and have a greater number of parameters compared to empirical models. As a consequence, they are not that useful in an industrial context. Their development is time-consuming and a number of mechanistic observations (e.g., flow cytometry analyses, biochemical, immunological markers measurements etc.) are required to avoid the identifiability problems due to the “overparametrization”.

The situation becomes even more complex when the effect of the treatment with an anticancer drug needs to be considered (R. K. Sachs, L. R. Hlatky and P. Hahnfeldt, “Simple ODE Models of Tumor Growth and Anti-Angiogenic or Radiation Treatment”. Mathematical and Computer Modelling, 33: 1297-1305, 2001; A. Iliadis and D. Barbolosi, “Optimizing Drug Regimens in Cancer Chemotherapy by an Efficacy-Toxicity Mathematical Model”. Computers and Biomedical Research, 33: 211-226, 2001, D. Miklavèiè, T. Jarm, R. Karba and G. Ser\check{s}a, “Mathematical modeling of tumor growth in mice following electrotherapy and bleomycin treatment”. Mathematics and Computers in Simulation, 39: 597-602, 1995; Panetta J. C. A mathematical model of breast and ovarian cancer treated with paclitaxel. Mathl Biosci 1997, 146, 89-113) due to the uncertainties regarding the mode of action.

A first attempt for simplifying the problem was proposed by Dagnino G, Rocchetti M, Urso R, Guaitani A, Bato\check{s}ek I. Mathematical modeling of growth kinetics of Walker 256 carcinoma in rats. Oncology 1983, 40, 143-147, (referred hereinafter as Tumor Perfusion Model), the growth of a population of tumor cells is limited by the availability of nourishment perfused to the neoplastic tissue by the systemic circulation. The fundamental hypothesis is that the perfusion capability, then the delivery of nutrients, decreases with the expansion of the neoplastic tissue and, consequently, the reduction of the growth rate of the tumor mass. The phase of growth is thus subdivided in three phases:
I. The starting period, during which the delivery of nutrients is sufficient for all neoplastic cells, identifiable with the interval [0, t_{1].}
II. An intermediate period, during which the total blood flow reaches all the tumor cells, but can not adequately satisfy their nutrition requirements, identifiable with the interval [t₁, t_{2].}
III. The final phase, during which the tumor mass largely exceeds the capability of an adequate blood perfusion, identifiable with the interval [t₂, ∞].

Starting from the subdivision of tumor cells in two populations (the proliferating and the quiescent ones) and denoting the respective masses with L(t) and with M(t), the model determines an expression for the total weight W(t) of the tumor in each of the three phases of growth. Consider the following system of differential equations:

$$\begin{matrix}\frac{ⅆ L}{ⅆ t} = [ λ ( t ) - μ ( t ) ] \cdot L ( t ) & ( 5.2 ) \\ \frac{ⅆ M}{ⅆ t} = μ ( t ) \cdot L ( t ) & ( 5.3 )\end{matrix}$$

with initial conditions L(0)=L₀ and M(0)=0, in which the functions λ(t) and μ(t) represent respectively the reproduction rate of new cells and the rate of passage from proliferation to quiescence.

For each of the three phases it results:

$$\begin{matrix}λ ( t ) = {λ}_{0} , μ ( t ) = 0 & I . \\ λ ( t ) = \frac{{λ}_{1}}{W ( t )} , μ ( t ) = 0 & II . \\ λ ( t ) = {λ}_{2} , μ ( t ) = {μ}_{2} ( t ) & III .\end{matrix}$$

Referring to Dagnino et al. (ditto) for the calculations, an analytical expression for the macroscopic weight of the tumor W(t)=L(t)+M(t) in the three phases is provided:
W(t)=L₀·exp(λ₀ 0≦t≦t₁ (5.4)
W(t)=L₀·exp(λ₀·t₁)+λ₁·(t−t₁≦t≦t₂ (5.5)

$$W ( t ) = [ {L}_{0} \cdot exp ( {λ}_{0} \cdot {t}_{1} ) + {λ}_{1} \cdot ( {t}_{2} - {t}_{1} ) ] \cdot \\ \frac{{μ}_{2} - {λ}_{2} \cdot exp ( - ( {μ}_{2} - {λ}_{2} ) \cdot ( t -}{{μ}_{2} - {λ}_{2}} \\ t \geq {t}_{2} \qquad ( 5.6 )$$

satisfying the conditions λ₀^{·}W(t₁)=λ₂ and λ₀^{·}W(t₂)=λ₁ in order to ensure W(t)εC¹.

FIG. 24 shows the profile of growth in the three phases: phase I is of exponential growth till a time threshold (t₁); after that a phase of linear growth is observed (phase II) till the time t₂, beyond which a phase (phase III) of asymptotic proceeding toward a plateau is observed. It must be underlined however that phase III is hardly reached in the in vivo experimentations (tumor lines with slow growth and able to guarantee a long survival to the subject are needed); it often happens, in fact, that the death of the mouse or the ulceration of the tumor are recorded during phase II, causing the interruption of the experimental observation when the weight of the tumor is still very distant from the phase of proceeding toward the plateau. It seems therefore opportune to limit the observation of the growth curve of the tumor to the first two phases for which, besides, experimental measurements of the weight are available, without involving the last phase that would require the use of two specific parameters λ₂ and μ₂, without the support of adequate experimental data.

Although this model was efficient enough for describing the tumor growth, the equations therein used (5.4 and 5.6) describe only the tumor growth broken in the different steps and it did not include the effect of a possible treatment.

A method which makes the best use of all the information generated during the preclinical studies and applicable in the pharmaceutical field is still missing.

### SUMMARY OF THE INVENTION

An object of the invention is therefore to provide a method for estimating or predicting the anti-tumor activity of a compound administered to mammals developing a tumor as well as a method for estimating or predicting the tumor growth in said mammals which result to be sufficiently simple and allow to get good estimates or predictions regardless of the uncertainties on the mode of action.

Among the objects of the invention, there is that of employing a small number of parameters so to be useful in an industrial context and therefore avoiding time consumption as well as a number of mechanistic observations.

A further object of the invention is that of estimating or predicting different schedules of the tested compound, therefore permitting a better understanding of the mechanism of action of the compound as well as to optimise the experimental designs and results.

Still further, an object of the invention is that of providing a method which may increase the throughput of tumor growth inhibition experiments, permits less schedules to be tested and a lower number of mammals and lower amounts of the tested compound to be used for evaluating the efficacy of the compound, and permits a classification and a comparison of tested compounds.

### BRIEF DESCRIPTION OF THE DRAWINGS

FIG. 1 is a graphic representation of the tumor weight of the eight mice of G1 (Experiment-A).

FIG. 2 is a graphic representation of the tumor weight of four mice of G2 (Experiment-A).

FIG. 3 is a graphic representation, in semi-logarithmic scale, of the plasma concentration (drug-A) of four mice of G2 (Experiment-A).

FIG. 4 is a graphic representation of the tumor weight of four mice of G3 (Experiment-A).

FIG. 5 is a graphic representation, in semi-logarithmic scale, of the plasma concentration (Drug-A) of four mice of G3 (Experiment-A).

FIG. 6 is a graphic representation of the tumor weight of four mice of G4 (Experiment-A).

FIG. 7 is a graphic representation, in semi-logarithmic scale, of the plasma concentration (Drug-A) of four mice of G4 (Experiment-A).

FIG. 8 is a graphic representation of the average tumor weight for the ten cages (G1-G10) (Experiment-C).

FIG. 9 shows a sequential scheme of the analysis according to a pharmacokinetic/pharmacodynamic (PK/PD) approach.

FIG. 10 shows a two-compartment pharmacokinetic model for Drug-A.

FIG. 11 shows the fitting of the PK model for the Experiment-A and is a graphic representation, in semi-logarithmic scale, of the observed and predicted data for the mouse 0.

FIG. 12 shows the fitting of the PK model for the Experiment-A and is a graphic representation, in semi-logarithmic scale, of the observed and predicted data for the mouse 31.

FIG. 13 shows the fitting of the PK model for the Experiment-A and is a graphic representation, in semi-logarithmic scale, of the observed and predicted data for the mouse 55.

FIG. 14 shows the fitting of the PK model for the Experiment-A and is a graphic representation, in semi-logarithmic scale, of the observed and predicted data for the mouse 69.

FIG. 15 shows the fitting of the PK model for the Experiment-A and is a graphic representation, in semi-logarithmic scale, of the observed and predicted data for the mouse 28.

FIG. 16 shows the fitting of the PK model for the Experiment-A and is a graphic representation, in semi-logarithmic scale, of the observed and predicted data for the mouse 59.

FIG. 17 shows the fitting of the PK model for the Experiment-A and is a graphic representation, in semi-logarithmic scale, of the observed and predicted data for the mouse 64.

FIG. 18 shows the fitting of the PK model for the Experiment-A and is a graphic representation, in semi-logarithmic scale, of the observed and predicted data for the mouse 88.

FIG. 19 shows the fitting of the PK model for the Experiment-A and is a graphic representation, in semi-logarithmic scale, of the observed and predicted data for the mouse 26.

FIG. 20 shows the fitting of the PK model for the Experiment-A and is a graphic representation, in semi-logarithmic scale, of the observed and predicted data for the mouse 78.

FIG. 21 shows the fitting of the PK model for the Experiment-A and is a graphic representation, in semi-logarithmic scale, of the observed and predicted data for the mouse 80.

FIG. 22 shows the fitting of the PK model for the Experiment-A and is a graphic representation, in semi-logarithmic scale, of the observed and predicted data for the mouse 81.

FIG. 23 shows a tri-compartmental PK model for the Drug-C.

FIG. 24 shows a characteristic profile of growth of the weight, according to a Tumor Perfusion Model.

FIG. 25 is a graphical representation of the differential form and determination of the weight threshold between the phase of exponential growth and the phase of linear growth according to a Tumor Perfusion Model.

FIG. 26 shows the time course of \dot{W} when varying the parameter Ψ.

FIG. 27 shows a particular time course of \dot{W} with Ψ=20.

FIG. 28 shows the growth model for the controls: observed and predicted values for the mouse 18 (Experiment-A).

FIG. 29 shows the growth model for the controls: observed and predicted values for the mouse 27 (Experiment-A).

FIG. 30 shows the growth model for the controls: observed and predicted values for the mouse 52 (Experiment-A).

FIG. 31 shows the growth model for the controls: observed and predicted values for the mouse 58 (Experiment-A).

FIG. 32 shows the growth model for the controls: observed and predicted values for the mouse 71 (Experiment-A).

FIG. 33 shows the growth model for the controls: observed and predicted values for the mouse 77 (Experiment-A).

FIG. 34 shows the growth model for the controls: observed and predicted values for the mouse 84 (Experiment-A).

FIG. 35 shows the growth model for the controls: observed and predicted values for the mouse 86 (Experiment-A).

FIG. 36 shows the growth model for the controls: observed and predicted values for the cage G1 (Experiment-C).

FIG. 37 shows a functional scheme of the pharmacodynamic effect.

FIG. 38 shows a functional scheme of the chain of mortality.

FIG. 39 shows a compartmental representation of the chain of mortality.

FIG. 40 shows a complete functional scheme of the model of tumor growth for treated subjects.

FIG. 41 shows the growth model for treated subjects: observed and predicted values for the mouse 0 (Experiment-A).

FIG. 42 shows the growth model for treated subjects: observed and predicted values for the mouse 31 (Experiment-A).

FIG. 43 shows the growth model for treated subjects: observed and predicted values for the mouse 64 (Experiment-A).

FIG. 44 shows the growth model for treated subjects: observed and predicted values for the mouse 78 (Experiment-A).

FIG. 45 shows the growth model for treated subjects: observed and predicted values for the cage G5 (Experiment-C).

FIG. 46 shows the growth model for treated subjects: observed and predicted values for the cage G7 (Experiment-C).

FIG. 47 shows the growth model for treated subjects: observed and predicted values for the cage G2, zoom on the initial phase of growth (Experiment-C).

FIG. 48 shows the growth model for treated subjects: observed and predicted values for the cage G5, zoom on the initial phase of growth (Experiment-C).

FIG. 49 shows the growth model for treated subjects: observed and predicted values for the cage G7, zoom on the initial phase of growth (Experiment-C).

### DETAILED DESCRIPTION OF THE INVENTION

These and other objects, which will be apparent from the understanding of the following description, are attained by the methods of the invention; in particular, according to a first aspect of the invention, by carrying out a method for estimating the anti-tumor activity of a compound administered to mammals developing a tumor comprising:
a) measuring the tumor weight in time;
b) measuring the concentration of the compound in time;
c) calculating, on the basis of said measures, the following kinetic parameters of the tumor growth:
a parameter (L₀), representative of the portion of the tumor cells present at the instant t₀=0 that succeeds in taking root and in starting the tumor cells proliferation in the mammals;
an index (λₒ) of the production rate of the tumor cells during an exponential phase of the tumor growth;
an index (λ₁) of the tumor cells mass produced in the time unit during a linear phase of the tumor growth;
   and the following pharmacodynamic parameters of the compound:
an index (K₁) of the tumor cells death rate;
an index (K₂) of the potency of the compound; and
d) calculating, on the basis of said kinetic and pharmacodynamic parameters, tumor growth curves.

A further parameter (ψ), representative of the tumor growth curves shape, is preferably calculated; in particular, L₀, λₒ, λ₁, K₁ and K₂ are calculated using a non-linear fitting program, which finds the best combination of the parameters, comparing -in time- the measured tumor weights with the tumor weights calculated by the program, by the following system of ordinary differential equations and initial conditions:

$$\begin{matrix}{\dot{Z}}_{1} = \frac{{λ}_{0} \cdot {Z}_{1} ( t )}{{[ 1 + {( \frac{{λ}_{0}}{{λ}_{1}} \cdot W ( t ) )}^{ψ} ]}^{\frac{1}{ψ}}} - {K}_{2} \cdot c ( t ) \cdot {Z}_{1} ( t ) {Z}_{1} ( 0 ) = {L}_{0} & ( 6.8 ) \\ {\dot{Z}}_{2} ( t ) = {K}_{2} \cdot c ( t ) \cdot {Z}_{1} ( t ) - {K}_{1} \cdot {Z}_{2} ( t ) {Z}_{2} ( 0 ) = 0 & ( 6.9 ) \\ … & \\ \dot{Z} i ( t ) = {K}_{1} \cdot {Z}_{i - 1} ( t ) - {K}_{1} \cdot {Z}_{n} ( t ) {Z}_{n} ( 0 ) = 0 & ( 6.11 )\end{matrix}$$

wherein
L₀, λₒ, λ₁, K₁, K₂ and Ψ are as above defined;
Z₁(t), 1 being the state of the cells in the growing phase, is a function of the tumor mass damageable by the compound at the time (t);
Zᵢ(t) is a state variable, i-ranging from 2 to n-, representing damaged tumor cells that transit through n-1 compartments which represent the different tumor cells state and which form a chain of mortality; c(t) is a function representing the compound concentration in time;
the calculated tumor weight W(t), representing both the set of the tumor cells not damaged by the compound pharmacological action and the set of the tumor cells in transit inside the chain of mortality, being

$$W ( t ) = {\sum }_{i = 1}^{n} {Z}_{i} ( t ) \qquad ( 6.6 )$$

wherein Zᵢ(t), i and t are as above defined.

Preferably, the method for estimating the anti-tumor activity comprises evaluating the survival time (τ) of damaged tumor cells in transit inside the chain of mortality, described through a random variable τ for which a probability density function pdf(τ) is considered; said pdf(τ) being described, by applying a compartmental model comprising n-1 compartments, as above defined, with first-order kinetics, regulated by K₁ and Zᵢ(t) as above defined; said compartmental model being described by the following system of differential equations:
\dot{Z}₂(t)=K₂·c(t)·Z₁(t)−K₁·Z₂(t)
\dot{Z}₃(t)=K₁·Z₂(t)−K₁·Z₃(t) (6.2)
\dot{Z}ᵢ(t)=K₁·Zᵢ₋₁(t)−K₁·Zₙ(t)
wherein Zᵢ(t), i, t, n, K₁ and K₂ are as above defined; under the hypothesis that the tumor mass in exit in the time unit from a compartment is proportional to the resident mass according to K₁ and considering that the growth of Z₁(t) is
\dot{Z}₁(t)=f(W(t))−K₂·c)(t)·Z₁(t) (6.1)
wherein f(W(t)) represents the equation of the tumor growth of the mammals to which the compound has not been administered, function of the tumor total weight W(t).

The probability density function pdf(τ) has generally a bell-like shape and is an Erlang(n-1, K₁):

$$pdf ( τ ) = \begin{matrix}{K}_{1} \cdot exp ( - {K}_{1} \cdot t ) \cdot \frac{{( {K}_{1} \cdot t )}^{n - 2}}{( n - 2 ) !} & t = 0 \\ 0 & otherwise\end{matrix} \qquad ( 6.4 )$$

wherein K₁, t and n are as above defined;
the mean value E[τ] and variance Var[τ] of the survival time τ resulting, respectively, from:

$$\begin{matrix}E [ τ ] = \frac{n - 1}{{K}_{1}} & ( 6.5 ) \\ Var [ τ ] = \frac{n - 1}{{K}_{1}^{2}} & ( 6.13 )\end{matrix}$$

wherein K₁ and n are as above defined;
the related function of cumulative probability distribution resulting from:

$$F ( t ) = P ( τ \leq t ) = \{ \begin{matrix}1 - {\sum }_{j = 0}^{n - 2} exp ( - {K}_{1} t ) \frac{{( {K}_{1} t )}^{j}}{j !} & t \geq 0 \\ 0 & otherwise\end{matrix} \qquad ( 6.14 )$$

wherein F(t) represents the probability that the survival time τ of a damaged cell is less than a specified time t and K₁, j (ranging from 0 to n-2), t and n are as above defined. In particular, the tumor growth curves can be determined by the program represented by the following system of ordinary differential equations and initial conditions:

$${\dot{Z}}_{1} = \frac{{λ}_{0} \cdot {Z}_{1} ( t )}{{[ 1 + {( \frac{{λ}_{0}}{{λ}_{1}} \cdot W ( t ) )}^{ψ} ]}^{\frac{1}{ψ}}} - {K}_{2} \cdot c ( t ) \cdot {Z}_{1} ( t ) {Z}_{1} ( 0 ) = {L}_{0} \qquad ( 6.8 )$$

\dot{Z}₂(t)=K₂·c(t)·Z(t)−K₁·Z₂(t) z₂(0)=0 (6.9)
\dot{Z}₃(t)=K₁·Z₂(t)−K₁ Z₃(t) Z₃(0)=0 (6.10)
\dot{Z}₄(t)=K₁·Z₃(t)−K₁·Z₄(t) Z₄(0)=0 (6.11′)
wherein:
Z₂(t) to Z₄(t) are state variables representing damaged tumor cells that transit through the compartments 2, 3 and 4, respectively, forming the chain of mortality; and
K₁, K₂, λₒ, λ₁, c(t), L₀, Ψ and Z₁(t) are as above defined;
the function W(t) of the tumor weight in time resulting from
   W(t)=Z₁(t)+Z₂(t)+Z₃(t)+Z₄(t) (6.12)
   wherein W(t) is a function of the tumor weight in time and Z₁(t) to Z₄(t) are as above defined.

Ψ is preferably fixed to 20 while the best combination of the above kinetic and pharmacodynamic parameters may be carried out by the technique of the weighed least squares; the tumor measurement error may be determined by the following measurement error model:
D_{MIN}=D\hat{ }_{MIN}+ε_{MIN} (3.3)
D_{MAX}=D\hat{ }_{MAX}+ε_{MAX} (3.4)
wherein D_{MIN} and D_{MAX} represent the real smallest and largest diameters of the tumor mass, respectively; D\hat{ }_{MIN} and D\hat{ }_{MAX} represent the experimental values of D_{MIN} and D_{MAX} and ε_{MIN} and ε_{MAX} represent the measurement errors, for which it is assumed that:
   Var[ε_{MIN}]=CV^{2·}D²_{MIN} (3.5)
   Var[ε_{MAX}]=CV^{2·}D²_{MAX} (3.6)
   wherein CV is a constant representing the coefficient of variation and Var is the variance, asssuming the presence of an error of additive type proportional to the real value of the diameters. Approximating D_{MIN}≅D_{MAX}, the variance of the tumor weight is:
   Var[Ŵ]≅ξ²·W² (3.8)
   wherein Ŵ is the experimental value of W and ξ is a proportionality factor to CV.

Preferably, the calculation of the tumor growth curves comprises a delay of time (t_{lag}) between the moment in which the tumor mass is damaged by the aggression of the compound and the instant in which the mass enters the chain of mortality; in particular this can be realised inserting a delay in the time of administration of the compound to the mammals.

To estimate the anti-tumor activity of the compound, the kinetic parameters K₁ and K₂ may be either directly measured or derived from known estimates of the same tumor cell line on the same mammals obtained by previous experiments.

A second aspect of the invention concerns a method for predicting the anti-tumor activity of a compound administered to mammals developing a tumor, comprising:
a) measuring the concentration of the compound in time;
b) assigning values to the parameters L₀, λₒ, λ₁, K₁, K₂, and ψ, said parameters being defined as in claim 1 and 2, considering that L₀ is an estimate of the portion of the tumor cells present at the instant t₀=0 that succeeds in taking root and in starting the tumor cells proliferation in the mammals; λₒ is an estimate of the production rate of the tumor cells during an exponential phase of the tumor growth; λ₁ is an estimate of the tumor cells mass produced in the time unit during a linear phase of the tumor growth; K₁ is an estimate of (n-1)/E[τ], where E[τ] is the expected value of the survival time τ of a damaged tumor cell; K₂ is an estimate of λₒT/AUC, where AUC is the area under the curve of the concentration of the compound in a given mammal and T is the time delay between the linear phase of the tumor growth in that given mammal and the tumor growth curve of the mammals to which the compound has not been administered; and
c) calculating, on the basis of said measure and of the parameters assigned values, tumor growth curves. ψ is preferably fixed to 20 while the tumor growth curves may be calculated using a program which predicts the tumor weight by the following system of ordinary differential equations and initial conditions:

$$\begin{matrix}{\dot{Z}}_{1} = \frac{{λ}_{0} \cdot {Z}_{1} ( t )}{{[ 1 + {( \frac{{λ}_{0}}{{λ}_{1}} \cdot W ( t ) )}^{ψ} ]}^{\frac{1}{ψ}}} - {K}_{2} \cdot c ( t ) \cdot {Z}_{1} ( t ) {Z}_{1} ( 0 ) = {L}_{0} & ( 6.8 ) \\ {\dot{Z}}_{2} ( t ) = {K}_{2} \cdot c ( t ) \cdot {Z}_{1} ( t ) - {K}_{1} \cdot {Z}_{2} ( t ) {Z}_{2} ( 0 ) = 0 & ( 6.9 ) \\ … & \\ \dot{Z} i ( t ) = {K}_{1} \cdot {Z}_{i - 1} ( t ) - {K}_{1} \cdot {Z}_{n} ( t ) {Z}_{n} ( 0 ) = 0 & ( 6.11 )\end{matrix}$$

wherein
L₀, λₒ, λ₁, K₁, K₂, Ψ, Zᵢ(t) to Zi(t), i, t, n and c(t) are as above defined;
the calculated tumor weight W(t), representing both the set of the tumor cells not damaged by the compound pharmacological action and the set of the tumor cells in transit inside the chain of mortality, being

$$W ( t ) = {\sum }_{i = 1}^{n} {Z}_{1} ( t ) \qquad ( 6.6 )$$

wherein Zᵢ(t), i, t and n are as above defined.

Preferably, the method for method for predicting the anti-tumor activity of a compound according to the invention comprises evaluating the survival time (τ) of damaged tumor cells in transit inside the chain of mortality, described through a random variable τ for which a probability density function pdf(τ) is considered; said pdf(τ) being described, by applying a compartmental model comprising n-1 compartments, as above defined, with first-order kinetics, regulated by K₁ and Zᵢ(t) as above defined; said compartmental model being described by the following system of differential equations:
\dot{Z}₂(t)=K₂·c(t)·Z₁(t)−K₁·Z₂(t)
\dot{Z}₃(t)=K₁·Z₂(t)−K₁·Z₃(t) (6.2)
\dot{Z}ᵢ(t)=K₁·Zᵢ₋₁(t)−K₁·Zₙ(t)
wherein Zᵢ(t), i, t, n, K₁ and K₂ are as above defined; under the hypothesis that the tumor mass in exit in the time unit from a compartment is proportional to the resident mass according to K₁ and considering that the growth of Z₁(t) is
\dot{Z}₁(t)=f(W(t)−K₂·c(t)·Z₁(t) (6.1)
wherein f(W(t)) represents the equation of the tumor growth of the mammals to which the compound has not been administered, function of the tumor total weight W(t).

The probability density function pdf(,) has preferably a bell-like shape and is an Erlang (n-1, K₁):

$$pdf ( τ ) = \begin{matrix}{K}_{1} \cdot exp ( - {K}_{1} \cdot t ) \cdot \frac{{( {K}_{1} \cdot t )}^{n - 2}}{( n - 2 ) !} & t = 0 \\ 0 & otherwise\end{matrix} \qquad ( 6.4 )$$

wherein K₁, t and n are as above defined;
the mean value E[τ] and variance Var[τ] of the random variable τ resulting, respectively, from:

$$\begin{matrix}E [ τ ] = \frac{n - 1}{{K}_{1}} & ( 6.5 ) \\ Var [ τ ] = \frac{n - 1}{{K}_{1}^{2}} & ( 6.13 )\end{matrix}$$

wherein K₁ and n are as above defined;
the related function of cumulative probability distribution resulting from:

$$F ( t ) = P ( τ \leq t ) = \{ \begin{matrix}1 - {\sum }_{j = 0}^{n - 2} exp ( - {K}_{1} t ) \frac{{( {K}_{1} t )}^{j}}{j !} & t \geq 0 \\ 0 & otherwise\end{matrix} \qquad ( 6.14 )$$

wherein F(t) represents the probability that the survival time τ of a damaged cell is less than a specified time t and K₁, j (ranging from 0 to n-2), t and n are as above defined.

The tumor growth curves may be calculated using a program which predicts the tumor weight by the following system of ordinary differential equations and initial conditions:

$${\dot{Z}}_{1} = \frac{{λ}_{0} \cdot {Z}_{1} ( t )}{{[ 1 + {( \frac{{λ}_{0}}{{λ}_{1}} \cdot W ( t ) )}^{ψ} ]}^{\frac{1}{ψ}}} - {K}_{2} \cdot c ( t ) \cdot {Z}_{1} ( t ) {Z}_{1} ( 0 ) = {L}_{0} \qquad ( 6.8 )$$

\dot{Z}₂(t)=K₂19 c(t)·Z₁(t)−K₁·Z₂(t) Z₂(0)=0 (6.9)
\dot{Z}₃(t)=K₁·Z₂(t)−K₁·Z₃(t) Z₃(0)=0 (6.10)
\dot{Z}₄(t)=K₁·Z₃(t)−K₁·Z₄(t) Z₄(0)=0 (6.11′)
wherein:
K₁, K₂, λₒ, λ₁, c(t), L₀, ψ and Z₁(t) to Z₄(t) are as above defined;
the function [W(t)] of the tumor weight in time resulting from
   W(t)=Z₁(t)+Z₂(t)+Z₃(t)+Z₄(t) (6.12)
   wherein W(t) is a function of the tumor weight in time and Z₁(t) to Z₄(t) are as above defined.

The compound tested according to the invention is preferably an antitumor agent. In particular, the compound is paclitaxel or brostallicin.

The concentration of the compound is either directly measured or indirectly determined from pharmacokinetics models of interspecies scaling i.e. extrapolating the concentration of the compound from known experimental data on different species (see, f.i. Dedrick R L. Animal scale-up, Journal of Pharmacokinetics & Biopharmaceutics. 1(5):435-61, 1973 October UI: 4787619; Boxenbaum H., “Time concepts in physics, biology, and pharmacokinetics”, Journal of Pharmaceutical Sciences. 75(11):1053-62, 1986 November; Mordenti J. “Man versus beast: pharmacokinetic scaling in mammals”, Journal of Pharmaceutical Sciences. 75(11):1028-40, 1986 November) The concentration of the tested compound is preferably measured in plasma, serum or tissue.

The above methods, according to the first and second aspects of the invention, can also be advantageously carried out for evaluating the mechanism of action of a compound administered to mammals developing a tumor. In particular, the tumor growth curves can be calculated using a program which predicts the tumor weight by the following system of ordinary differential equations and initial conditions:

$$\begin{matrix}{\dot{Z}}_{1} = \frac{{λ}_{0} \cdot {Z}_{1} ( t )}{{[ 1 + {( \frac{{λ}_{0}}{{λ}_{1}} \cdot W ( t ) )}^{ψ} ]}^{\frac{1}{ψ}}} - {K}_{2} \cdot c ( t ) \cdot {Z}_{1} ( t ) {\sum }_{i = 2}^{n} {γ}_{i} {Z}_{i} ( t ) {Z}_{1} ( 0 ) = {L}_{0} \\ {\dot{Z}}_{2} ( t ) = {K}_{2} \cdot c ( t ) \cdot {Z}_{1} ( t ) - ( {K}_{1} + {γ}_{2} ) \cdot {Z}_{2} ( t ) {Z}_{2} ( 0 ) = 0 \\ … \\ \dot{Z} i ( t ) = {K}_{1} \cdot {Z}_{i - 1} ( t ) - ( {K}_{1} + {γ}_{n} ) \cdot {Z}_{n} ( t ) {Z}_{n} ( 0 ) = 0\end{matrix}$$

wherein γᵢ is an index, possibly equal to zero, of the rate of tumor cells in the i-th compartment that recover from their damage, while L₀, λₒ, λ₁, K₁, K₂, Ψ, Z₁(t), Zᵢ(t), i, n, t and c(t) are as above defined; the calculated tumor weight W(t) being

$$W ( t ) = {\sum }_{i = 1}^{n} {Z}_{i} ( t ) \qquad ( 6.6 )$$

wherein Zᵢ(t), i, n and t are as above defined.

Further, the above methods, according to the first and second aspects of the invention, can also be advantageously carried out for estimating a minimal steady state compound concentration to be maintained for observing tumor regression in in vivo experiments. In fact, it comes out, from (6.8-6.11), that under a constant compound concentration, the zero state, corresponding to a tumor weight equal to zero is a stable equilibrium if the concentration is greater than λ₀/K₂ (which corresponds to the minimal steady state concentration of the compound).

Still further, the above methods, according to the first and second aspects of the invention, can also be advantageously carried out for testing the additivity of the effect of at least two compounds on the tumor growth in in vivo experiments; in particular, the tumor growth curves are calculated using a program which predicts the tumor weight by the following system of ordinary differential equations and initial conditions:

$$\begin{matrix}{\dot{Z}}_{1} = \frac{{λ}_{0} \cdot {Z}_{1} ( t )}{{[ 1 + {( \frac{{λ}_{0}}{{λ}_{1}} \cdot W ( t ) )}^{ψ} ]}^{\frac{1}{ψ}}} - {Z}_{1} ( t ) {\sum }_{j = 1}^{d} {K}_{2 j} \cdot {c}_{j} ( t ) {Z}_{1} ( 0 ) = {L}_{0} \\ {\dot{Z}}_{2 j} ( t ) = {Z}_{1} ( t ) {K}_{2 j} \cdot {c}_{j} ( t ) - {K}_{1 j} \cdot {Z}_{2 j} ( t ) {Z}_{2 j} ( 0 ) = 0 \\ … \\ {\dot{Z}}_{ij} ( t ) = {K}_{1 j} \cdot {Z}_{i - 1 , j} ( t ) - {K}_{1 j} \cdot {Z}_{ij} ( t ) {Z}_{ij} ( 0 ) = 0\end{matrix}$$

wherein:
L₀, λₒ, λ₁, K₁, Ψ, Z₁(t), Zᵢ(t), i, n, and t are as above defined; K₁ⱼ is an index of the tumor cells death rate of the j-th compound; K₂ⱼ is and index of the potency of the j-th compound; Zᵢⱼ(t) is a state variable, i -ranging from 2 to n- and j ranging 1 to d (d being the number of the compounds), representing damaged tumor cells that transit through n-1 compartments, which represent the different tumor cells state and which form a chain of mortality regulated by K₁ⱼ of the j-th compound; and cⱼ(t) is a function representing the concentration of the j-th compound;
the calculated tumor weight W(t) being

$$W ( t ) = {Z}_{1} ( t ) + {\sum }_{j = 1}^{d} {\sum }_{i = 2}^{n} {Z}_{ij} ( t ) \qquad ( {6.6}^{′} )$$

wherein Zᵢⱼ(t), i, j, d, n and t are as above defined.

Still further, the invention concerns the use of the calculation of the tumor growth curves according to any of the above aspects of the invention, for predicting the optimal administration dosage/schedule of a compound for the preparation of a medicament for the treatment of tumor.

A third aspect of the invention concerns a method for estimating the tumor growth in mammals developing a tumor, comprising:
a) measuring the tumor weight in time;
b) calculating, on the basis of said measures, the parameters L₀, λₒ, λ₁, said parameters being defined as above defined;
c) calculating, on the basis of said parameters, tumor growth curves.

The parameter A, as above defined, is also preferably calculated or, more preferably, it can be fixed to 20. The tumor growth may be calculated by a statistical program and defined by the following function:

$$W = \frac{{λ}_{0} \cdot W \text{?}}{[ 1 + ( \frac{{λ}_{0}}{{λ}_{1}} \cdot W \text{?}} W ( 0 ) = {L}_{0} \\ \text{?} \text{indicates text missing or illegible when filed} \qquad ( 5.13 )$$

wherein:
W(t), t, λₒ, λ₁ and Ψ are as above defined.

The tumor measurement error can be determined by the measurement error model above illustrated for the method for estimating the anti-tumor activity.

A fourth aspect of the invention concerns a method for predicting the tumor growth in mammals developing a tumor, comprising:
a) assigning values to the parameters L₀, λₒ, λ₁ and ψ, said parameters being as above defined, considering that L₀ is an estimate of the portion of the tumor cells present at the instant t₀=0 that succeeds in taking root and in starting the tumor cells proliferation in the mammals; λₒ is an estimate of the production rate of the tumor cells during an exponential phase of the tumor growth; λ₁ is an estimate of the tumor cells mass produced in the time unit during a linear phase of the tumor growth; and
b) calculating, on the basis of the parameters assigned values, tumor growth curves.

ψ is preferably fixed to 20 whereas the tumor growth may be calculated by a statistical program and defined by the following function:

$$\dot{W} = \frac{{λ}_{0} \cdot W ( t )}{{[ 1 + {( \frac{{λ}_{0}}{{λ}_{1}} \cdot W ( t ) )}^{ψ} ]}^{\frac{1}{ψ}}} W ( 0 ) = {L}_{0} \qquad ( 5.13 )$$

wherein:
W(t), t, L₀, λₒ, λ₁ and Ψ are as above defined.

The non-linear fitting or statistical program for any of the methods of the invention is preferably WinNonLin® 3.1.

The above illustrated methods of the invention preferably comprise a statistical program simultaneously fitting tumor growth curves of individual values or of the mean values for implementing any of the above methods; in particular, the statistical program is NONMEM, a software for population pharmacokinetic analysis which can be supplied by the NONMEM Project Group C255 University of California at San Francisco, San Francisco, Calif. 94143.

Any of the methods of the invention are preferably carried out by subcutaneously inoculating the mammals, in particular nude mice, with tumor cells so to develop a tumor. The parameter L₀ would therefore be, according to this preferred embodiment of the invention, representative of the portion of the inoculated tumor cells that succeeds in taking root and in starting the tumor cells proliferation in subcutaneous tissues of the mammals.

A further aspect of the invention also concerns a computer program for estimating or predicting the anti-tumor activity of a compound administered to mammals developing a tumor, or for estimating or predicting the tumor growth in said mammals comprising computer code means for implementing any of the above illustrated aspects of the invention.

The term “mammals” is herein meant to refer to animals only whereas either the term “compound” or “drug” are herein meant to comprise any molecule tested either for estimating or predicting the possible anti-tumor activity thereof.

According to a preferred embodiment of the invention, two different experiments were made in order to test the invention. These experiments are described in detail below. With these experiments some studies of efficacy of two supposedly anti-tumor drugs: drug-A and drug-C have been conducted regarding the in vivo growth of human tumor cell lines, inoculated in athymic nude mice.

Drug A is paclitaxel. Drug C is brostallicin; the compound is characterised in WO98/04524 and can be prepared as therein disclosed.

The two experiments involve the use of two populations of subjects: the controls and those subjects that receive the pharmacological treatment. The term “control” is preferred in the present specification to the term “not treated”: in fact, in order to eliminate the variables which invalidate the results, even on the mice that do not receive the drug, the administration of active excipients (vehicle or placebo) is practiced, as a rule, adopted together with the drug in order to improve its solubility and its ability of distribution in the tissues (Paroli E., “Farmacologia di base, preclinica, clinica”, Farmacologia clinica tossicologica, Soc. Editrice Universo, Roma, 1985; A. Henningsson, M. O. Karlsson, L. Viganò, L. Gianni, J. Verweij and A. Sparreboom, “Mechanism-Based Pharmacokinetic Model for Paclitaxel”, Journal of Clinical Oncology, 19 (n. 20-October 15): pp. 4065-4073, 2001). In all experiments, the tumor was inoculated into the animals in a subcutaneous position (on the back). The day of the inoculum was assumed as the origin of the time scale of the experiment and subsequently referred as day-0. The animals were divided in the different cages, maintained under sterile environmental conditions with controlled temperature and light (12 h/day), with free access to food and water (ad libitum). The pharmacological treatment (as the one with vehicle only for the controls) started at the end of the so-called “silent interval”(G. G. Steel, 1977, ditto). Such expression is often used for denoting the early phase of the tumor growth after the inoculum, wherein the tumor cells, even if present and proliferating, have not yet produced a detectable and measurable tumor mass. The first measurement of the tumor mass was executed as the treatment began.

The mice were then withdrawn from the cages and weighed, executing the measurements for the determination of the tumor mass as described in the experiments hereinafter; for some of them, plasmatic samples were drawn in order to determine the concentration of the selected drug.

At the end of the period of observation the animals were sacrificed for autoptic inspections.

The invention will be more apparent from the accompanying drawings, which are provided by way of non limiting example and wherein:

Experiment-A

The cell line GTL16 (human stomach carcinoma) was inoculated subcutaneously on the back of 44 athymic nude male mice, initially weighing 17.9-28.1 g. The animals were then subdivided in four cages:
I. Cage G1: the control group, consisting of 8 mice
II. Cage G2: 12 mice, treated with 3 intravenous rapid injections (iv-bolus) of Drug-A, repeated every 4 days (therapeutic regimen q4d×3), at the dosing of 20 mg/kg each.
III. Cage G3: 12 mice, treated with iv-bolus of Drug-A, in regimen q4d×3, at the dosing of 30 mg/kg.
IV. Cage G4: 12 mice, treated with iv-bolus of Drug-A, in regimen q4d×3, at the dosing of 40 mg/kg.

The treatment and the first measurement of the tumor mass took place on the eighth day after the inoculation. For each of the cages G2, G3 and G4, four mice were withdrawn for monitoring the plasma concentration of the drug. The experiment had a total duration of 40 days.

The following Tab.1 provides a summarizing scheme of the protocol adopted for the Experiment-A.

TABLE 1
Protocol adopted in the Experiment-A
Experiment-A

| | |
|---|---|
| Inoculated Cell Line: | GTL16 |
| Animals: | athymic nude mice |
| Sex: | M |
| Initial Weight Range: | 17.9-28.1 g |
| Experiment duration: | 40 days |
| Start of Treatment: | day 8 |
| Drug: | Drug-A |

| Cage | Treatment | Dose (mg/kg) | Therapeutic Regimen | No. of mice |
|---|---|---|---|---|
| G1 | control | | | 8 |
| G2 | iv-bolus | 20 | q4dx3 | 12 |
| G3 | iv-bolus | 30 | q4dx3 | 12 |
| G4 | iv-bolus | 40 | q4dx3 | 12 |

Experiment-C

The cell line H207 (ovarian human carcinoma) was inoculated subcutaneously on the back of 70 female athymic nude mice, initially weighing 17.0-25.0 g. The animals were then subdivided in ten cages:
I. Cage G1: the control group, consisting of 7 mice
II. Cage G2: 7 mice, treated with 3 iv-bolus of Drug-C, repeated every 7 days (therapeutic regimen q7d×3), at a dosing of 0.39 mg/kg.
III. Cage G3: 7 mice, treated with iv-bolus of Drug-C at the therapeutic regimen q7d×3, at a dosing of 0.52 mg/kg.
IV. Cage G4: 7 mice, treated with iv-bolus of Drug-C at the therapeutic regimen q7d×3, at a dosing of 0.78 mg/kg.
V. Cage G5: 7 mice, treated with 3 iv-bolus of Drug-C, repeated every 4 days (therapeutic regimen q4d×3), at a dosing of 0.26 mg/kg.
VI. Cage G6: 7 mice, treated with iv-bolus of Drug-C at the therapeutic regimen q4d×3, at a dosing of 0.39 mg/kg.
VII. Cage G8: 7 mice, treated with iv-bolus of Drug-C at the therapeutic regimen q4d×3, at a dosing of 0.52 mg/kg.
VIII. Cage G9: 7 mice, treated with 10 iv-bolus of Drug-C, subdivided in 2 cycles of treatment of 5 daily iv-bolus followed by 2 days of rest (therapeutic regimen qd×5×2 wks), at the dosing of 0.117 mg/kg each.
IX. Cage G10: 7 mice treated at the same treatment and therapeutic regimen of G4, but with the drug coming from a different batch of production.

In this case, despite the silent interval finished in correspondence of the tenth day (where the first measurement of the tumor mass was carried out), the chemotherapeutic treatment started in correspondence of the eleventh day. The experiment had a total duration of 89 days.

The following Tab. 3 provides a summarizing scheme of the protocol adopted for the Experiment-C.

TABLE 3
Protocol adopted in the Experiment-C Experiment-C

| | |
|---|---|
| Inoculated Cell Line: | H207 |
| Animals: | athymic nude mice |
| Sex: | F |
| Initial Weight Range: | 17.0-25.0 g |
| Experiment duration: | 89 days |
| Start of treatment: | day 11 |
| Drug: | Drug-C |

| Cage | Treatment | Dose (mg/kg) | Therapeutic Regimen | No. of mice |
|---|---|---|---|---|
| G1 | control | | | 7 |
| G2 | iv-bolus | 0.39 | q7dx3 | 7 |
| G3 | iv-bolus | 0.52 | q7dx3 | 7 |
| G4 | iv-bolus | 0.78 | q7dx3 | 7 |
| G5 | iv-bolus | 0.26 | q4dx3 | 7 |
| G6 | iv-bolus | 0.39 | q4dx3 | 7 |
| G7 | iv-bolus | 0.52 | q4dx3 | 7 |
| G8 | iv-bolus | 0.117 | qdx5x2wks | 7 |
| G9 | iv-bolus | 0.156 | qdx5x2wks | 7 |
| G10 | iv-bolus | 0.78 | q7dx3 | 7 |

Approximation of the tumor Mass

The dimensions of the tumor can be taken applying different types of measurements broadly classifiable as measurements of linear dimensions, of volume (or mass) and cell number. For tumors that maintain more or less a spherical morphology, as in the case of solid tumors, the measurement of the three principal diameters results the most adequate, as well as the most practiced solution. Nevertheless, in the case of subcutaneous tumors, the tumor can be considered of spherical shape only during the initial phase of growth; in the following phases, the dimension perpendicular to the skin is generally much smaller than the percutaneous dimensions, conferring to the mass a plaque-like shape or an hemi-ellipsoidal shape. In the experiments taken into consideration, only the dimensions of the two percutaneous diameters were directly measured with vernier calipers. The third dimension was not directly measured, because of the limited accessibility (which would have required a greater invasiveness), in the assumption that two measures were anyhow sufficient to guarantee a good approximation of the tumor mass (K. Rygaard and M. Spang-Thomsen, “Quantitation and Gompertzian analysis of tumor growth”. Breast Cancer Research and Treatment, 46: 303-312,1997).

The volume of a tumor can be indirectly calculated by applying the following empirical formula:

$$\text{Tumor Volume} = \frac{{D}_{MIN}^{2} \cdot {D}_{MAX}}{2} \qquad ( 3.1 )$$

where D_{MIN} and D_{MAX} denote, respectively, the smallest and the largest percutaneous diameter. Such empirical formula hypothesizes that the neoplasia has an ellipsoidal shape (D. A. Cameron, W. M. Gregory, A. Bowman, E. D. C. Anderson, P. Levack, P. Forouhi and R. F. C. Leonard, “Identification of long-term survivors in primary breast cancer by dynamic modeling of tumour response”. British Journal of Cancer, 83(1): 98-103, 2000, Hammond, L. A.; Hilsenbeck, S. G.; Eckhardt, S. G.; Marty, J; Mangold, G.; MacDonald, G. R.; Rowinsky, E. K.; Von Hoff, D. D; Weitman S. Enhanced antitumour activity of 6-hydroxymethylacylfulvene in combination with topotecan or paclitaxel in the MV522 lung carcinoma xenograft model. European Journal of Cancer 2000, 36, 2430-2436) obtained by the rotation of a hemi-ellipsoid (with D_{MIN} and D_{MAX} as axes of the percutaneous plane) around its largest axe. Assuming δ as a constant density equal to δ=10⁻³g/mm³, the empirical expression for the mass of the neoplasia results to be:

$$\text{Tumor weight} = δ \cdot \frac{{D}_{MIN}^{2} \cdot {D}_{MAX}}{2} \qquad ( 3.2 )$$

The Measurement Error Model

The measurement of the diameter of a tumor, on animals of laboratory, is not always an easy task even with the use of anaesthetics. In fact experimental tumors show a high variable firmness; as a consequence, in the case of the more flabby tumors, the entity of the measurement depends in a significant manner on the pressure which is applied to the caliper. A further complication is represented by the skin thickness which risks to spoil the measurement. In all these cases it is advisable either to indicate an average value of the measurements made by several observers or to employ a single observer throughout all the measurements of the experiment.

Despite the due precautions, the measurements of the two percutaneous diameters are to be considered not devoid of errors. In particular, the presence of an error which is of additive type and proportional to the real value of the diameter, according to the constant CV (coefficient of variation) is herein assumed. The effective measurements (D_{MIN} and D_{MAX}) are therefore bound to the real values of the two diameters (D_{MIN} and D_{MAX}) through the following relationships:
D_{MIN}=D\hat{ }_{MIN}+ε_{MIN} (3.3)
D_{MAX}=D\hat{ }_{MAX}+ε_{MAX} (3.4)
where ε_{MIN} and ε_{MAX} represent the measurement errors, for which it is assumed:
Var[ε_{MIN}]=CV^{2·}D²_{MIN} (3.5)
Var[ε_{MAX}]=CV^{2·}D²_{MAX} (3.6)
\hat{ }

Denoting the tumor weight with W and considering (3.2), it is then possible to obtain an expression for the tumor weight variance, Var[W]: \hat{ }

$$Var [ \hat{W} ] ≅ {( \frac{\partial \hat{W}}{\partial {D}_{MIN}} )}^{2} \cdot Var [ {ɛ}_{MIN} ] + {( \frac{\partial \hat{W}}{\partial {D}_{MAX}} )}^{2} \cdot Var [ {ɛ}_{MAX} ] \qquad ( 3.7 )$$

Substituting (3.5) and (3.6) into (3.7), with a further approximation D_{MIN}≅D_{MAX}, after some simple passages, it can be obtained:
Var[\hat{ }]≅ξ²·W² (3.8)
wherein Ŵ is the experimental value of W and ξ is a proportionality factor to CV.

The expression (3.8) allows to determine the optimal weighing strategy of the observed data, which can be used in the algorithm of non linear regression, by which the fitting is computed.

The Fitting

The software used for the fitting of the various models (both the PK model and the ones descriptive of the tumor growth) uses an algorithm of non linear regression based on the Least Squares and a Gauss-Newton algorithm with Levenberg-Hartley modification (H. O. Hartley, “The modified Gauss-Newton Method for the Fitting of Nonlinear Regression Functions by Least Squares”. Technometrics 3, 1961). Since the error model related to the various experimental measurements is unknown for fitting pharmacokinetic models, a standard least squares technique (Least Squares, LS) has been used according to what disclosed in J. V. Beck and K. J. Arnold, “Parameter Estimation in Engineering and Science”. John Wiley & sons, 1977, herein incorporated as a reference as far as the least square technique is concerned.

As it regards the model of tumor growth, the error model above introduced is instead known. For the observed measurements of a generic quantity y (for instance the weight of the tumor), the constant coefficient of variation error model (3.5 and 3.6) asserts that the standard deviation of the error varies linearly with the dimension the measured quantity. With an error model of this kind, the technique of the weighed least squares (Weighed Least Squares, WLS), described in M. E. Dagna, “Identificazione di modelli farmacocinetici di popolazione”; Università degli Studi di Pavia 1999, herein incorporated as far as the WLS technique is concerned, is more adequate. The WLS criterion determines the vector θ, of the parameters to be identified, so to minimize an objective function with the following structure

$${J}_{WLS} ( θ ) = {\sum }_{j} {w}_{j} \cdot {( {y}_{j} - {\hat{y}}_{j} )}^{2} \qquad ( 3.9 )$$

where y\hat{ }ⱼ denotes the j-th predicted value of the variable y (in correspondence of the observed value yⱼ, while the term wⱼ is the weight related to the j-th observation, proportional to the inverse of the variance of the j-th measurement error (defined by the 3.8). Such a weighing strategy, gives less importance to the residuals related to big values of the quantity y, taking into more account the residuals related to small values of the same quantity y. The standard LS technique is then a particular case of the WLS technique wherein a uniform weighing strategy is adopted.
The Experimental Data

The experimental observation, related to the two experiments described before, are graphically represented in FIGS. 1-8.

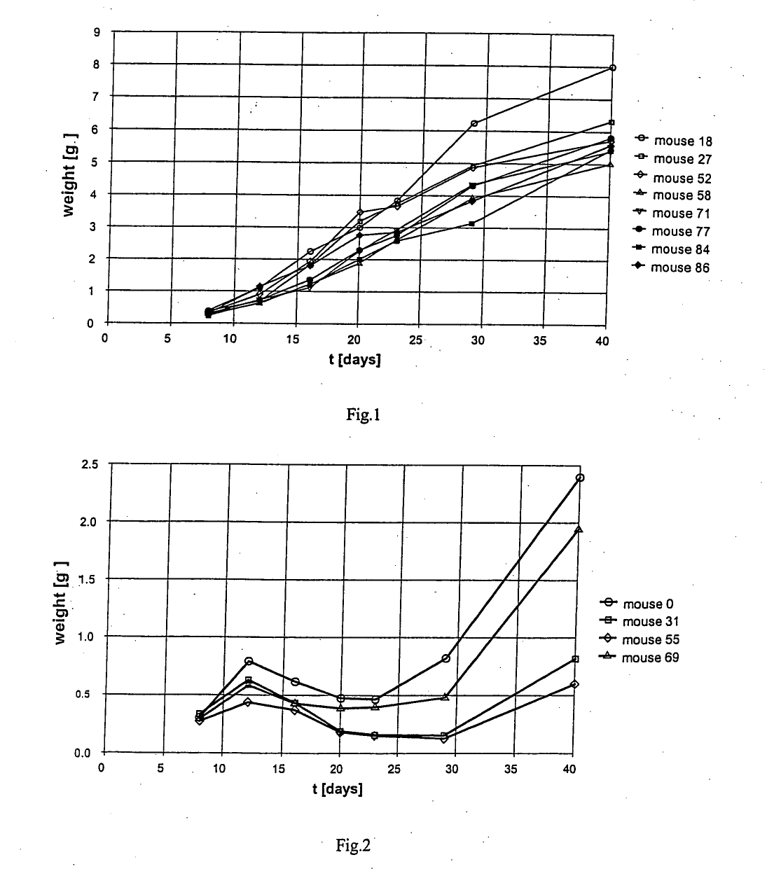

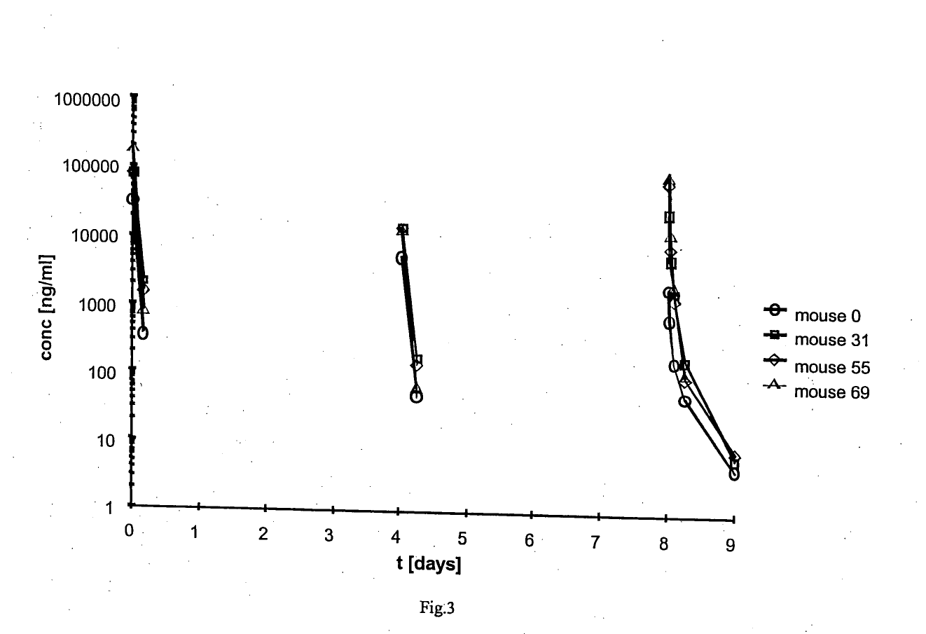

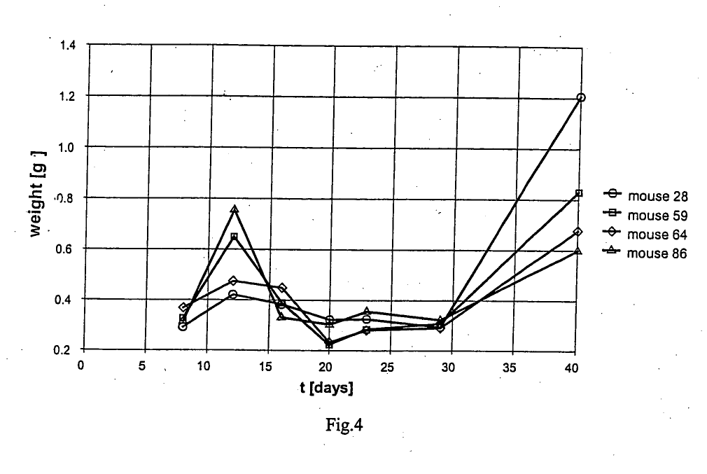

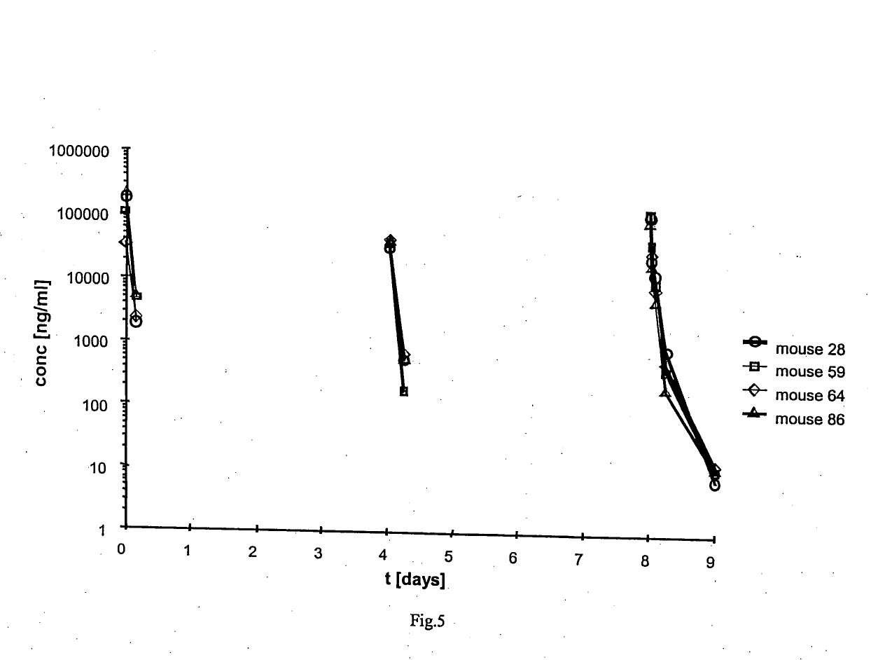

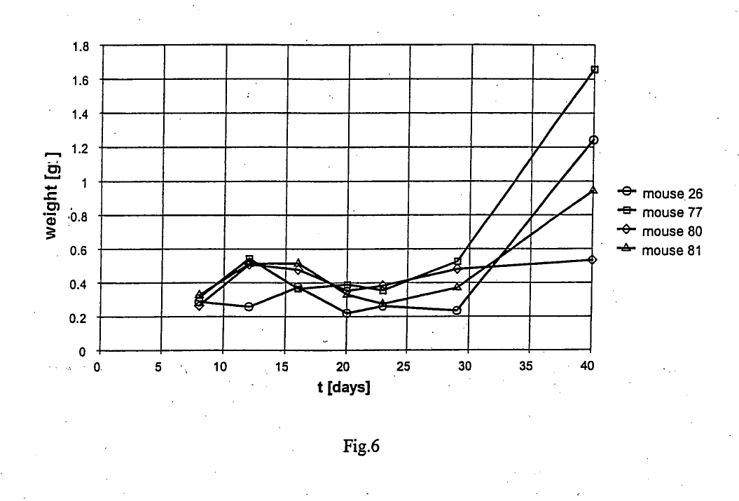

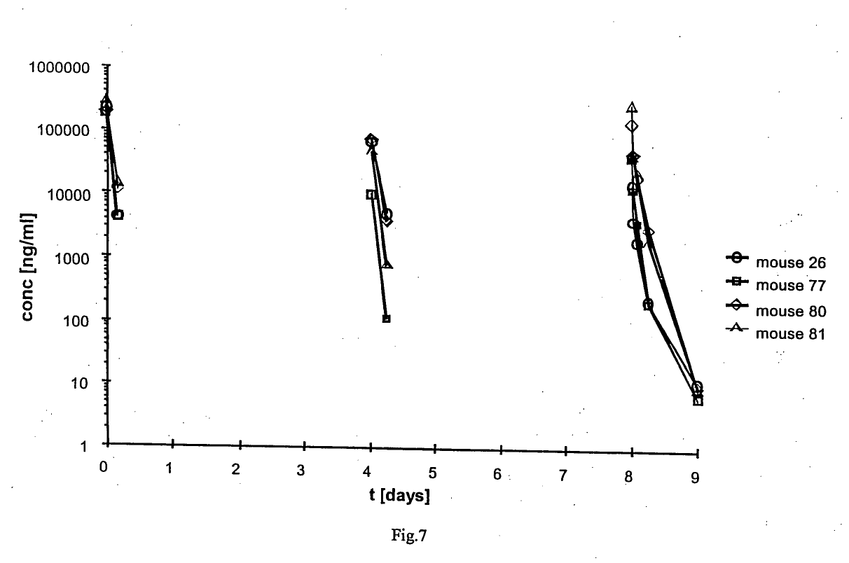

For the Experiment-A, the following data are available:
I. G1: individual measurement of the tumor weight for all the mice (FIG. 1) belonging to the control group
II. G2: individual measurement of the tumor weight and of the plasma concentration of the drug (Drug-A) for four mice of this cage (FIG. 2 and FIG. 3)
III. G3: individual measurement of the tumor weight and of the plasma concentration for four mice of this cage (FIG. 4 and FIG. 5)
IV. G4: individual measurement of the tumor weight and of the plasma concentration for four mice of this cage (FIG. 6 and FIG. 7)

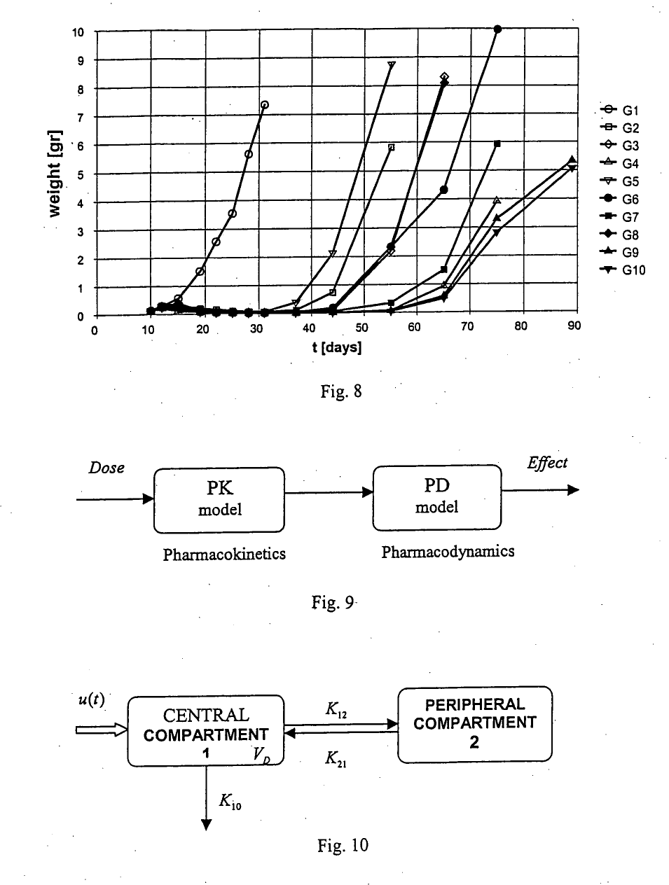

For the Experiment-C, the average measurements of the tumor weight are available (FIG. 8)

The Pharmacokinetic (PK) and Pharmacodynamic (PD) Approach

The most common approach to the in vivo pharmacokinetic and pharmacodynamic model identification involves the sequential analysis of the concentration of the tested compound versus time and therefore the study of the time course of the effect. The PK model, obtained in the first step, provides an independent function able to drive the dynamics (FIG. 9) (J. Gabrielsson, W. J. Jusko and L. Alari, “Modeling of Dose-Response-Time-Data: Four Examples of Estimating the Turnover Parameters and Generating Kinetic Functions from Response Profiles”. Biopharmaceutics & Drug Disposition, 21: 41-52, 2000).

The understanding of the basic concepts regarding the absorption of a drug, the distribution, metabolism and elimination (ADME), thereof as well as the relationship between kinetics and dynamics, is a fundamental aspect of the PK/PD modeling. Despite the purpose of this invention is beyond the treatment in detail of the pharmacokinetic theory, it is deemed to be opportune to introduce some fundamental concepts hereinafter applied.

Pharmacokinetics and Pharmacodynamics

Pharmacokinetics is the study of the rate and mechanism through which a drug is absorbed in the organism, distributes itself into it and is eliminated from it through metabolic and excretion processes. In less rigorous terms, pharmacokinetics is often defined as “what the body does to a drug and at which rate”, in opposition to pharmacodynamics, which studies “what the drug does to the body”. Strictly speaking, pharmacodynamics can be defined as the study of the biochemical and physiological effects of a drug and of its mechanism of action. Such discipline determines therefore, the relationship among the pharmacology response (effect) and the concentration of the drug or of some of its metabolites.

Pharmacokinetics is tipically studied measuring the time course of the drug concentration in plasma although, as above stated, in the present invention, the drug concentration can also be measured in serum or tissue. The profiles of the concentrations of the tested compound versus time can be described in empirical way (non-compartmental pharmacokinetics), defining the entities of the measured concentrations, the slopes (correlated to the rates of the processes) and the integral of the curve (AUC, Area Under the Curve). From a more modelistic point of view, the compartmental pharmacokinetics can be exploited; the organism, according to this approach, can be assimilated to a system of one or more compartments where the drug enters, distributes, degrades and is excreted. This does not mean that the compartment corresponds to a specific anatomical entity or to a real physiological one, but that it can be assimilated to a tissue or to a set of tissues which possess some affinities for the drug, within which the drug moves and goes out with a rate of change proportional to its concentration (first-order kinetics). In the models based on the compartmental analysis the tendency is to always employ the least number of compartments necessary to adequately describe the experimental results. In a multi-compartment model the drug is quickly distributed in those tissues that have high hematic flows: the blood and these highly perfused tissues constitute the central compartment. While this initial diffusion of the drug is taking place, it is also distributed in one or more peripheral compartments constituted by the less perfused tissues, having similar hematic flows and affinity for the drug. In this case, a multi stage exponential decay will be observed on the profile of the concentration of the tested compound versus time curve. Remembering the hypothesis which assumes a first-order kinetics associated to each compartment, a number of compartments equal to the number of exponential stages will be then employed. Compartmental pharmacokinetics is illustrated, for instance, in J. G. Wagner, “Biopharmaceutics and relevant Pharmacokinetics”. Drug Intell, Publ. Hamilton, 1971, M. Gibaldi and D. Perrier, “Pharmacokinetics”. Marcel Dekker, 2^{nd} Ed., New York, 1982, L. Shargel and A. B. C. Yu, “Biofarmaceutica Farmacocinetica”. Masson Italia Editori, Milano, 1984, M. Rowland and T. N. Tozer, “Clinical Pharmacokinetics: Concepts and Applications“. Lea & Fabinger, 2^{nd} Ed., 1989, J. Gabrielsson and D. Weiner, “Pharmacokinetic/Pharmacodynamic Data Analysis: Concept and Applications 2^{nd} Ed.”, Apotekar Societen, 1997 herein incorporated as a reference as far as this issue is concerned.

Experiment-A: PK model and fitting

From the observation of the experimental curve of the plasma concentration of Drug-A (FIGS. 3, 5 and 7) it is observed that, for all the twelve mice of Experiment-A, a bi-exponential decay is obtained in response to the treatment with the last bolus. Furthermore, by the moment that the drug is intravenously administered it is possible to consider that the process of drug absorption in the organism is instantaneous. Such considerations allow to model the pharmacokinetics of the drug, in response to the specific treatments adopted in the Experiment-A, through the two-compartment system represented in FIG. 10, in which the function u(t) represents the entering flow of the drug (amount of drug per unit of time).

The constant K₁₀ (expressed in day⁻¹) represents the constant rate of the elimination process (hypothesized only in the central compartment). K₁₂ and K₂₁ (expressed in day⁻¹) represent the interchange constant rates between the central compartment and the peripheral one. V_{D} is the so called apparent volume of distribution of the central compartment; it is expressed in ml kg⁻¹ and represents the hypothetical volume in which the drug dose would distribute if the distribution process was uniform.

“Pharmaceutical treatment” is herein meant to generically indicate whichever kind and route of administration of at least one selected compound; in the present experiment, an intravenous bolus of the drug dose D in input was administered at the time t₀. The absence of the absorption compartment allows to model the bolus, from the point of view of the central compartment, as a Dirac delta function centered around t₀ having an area equal to the administered dose D. According to the adopted bi-compartmental model, the concentration of the tested drug in the central compartment, in response to the single bolus, can be expressed by the following equation:
c(t)={A·exp[−α·(t−t₀)]+B·exp[−β(t−t₀)]}·H(t−t₀) (4.1)
in which H(^{·}) is the Heaviside unitary step function, while A, B, α and β are the four macro constants (characteristic parameters of the model), in contrast to K₁₀, K₁₂, K₂₁, and V_{c} (volume of distribution of the central compartment) called micro constants. Both types of constants can be univocally derived from one another and vice versa (as disclosed, f.i., in M. Gibaldi et al., 1982, ditto, herein incorporated as a reference as far as this issue is concerned).

The therapeutic regimen of the Experiment-A adopts the administration of three repeated intravenous boluses at the distance of four days each; the input function of central compartment is therefore expressible as:

$$u ( t ) = {\sum }_{i = 1}^{3} {D}_{G} \cdot δ ( t - {t}_{i} ) \qquad ( 4.2 )$$

wherein D_{G} and tᵢ represent the dose associated to each cage and the instants of administration (t₁=8, t₂=12, t₃=16) respectively. Exploiting the linearity of the compartmental models and the expression of the concentration in response to a single bolus is possible to analytically define the course of the concentration of the tested compound in response to the treatment specified by the (4.2):

$$c ( t ) = {\sum }_{i = 1}^{3} \{ A \cdot exp [ - α \cdot ( t - {t}_{i} ) ] + B \cdot exp [ - β \cdot ( t - {t}_{i} ) ] \} \cdot \\ H ( t - {t}_{i} ) \qquad ( 4.3 )$$

The bi-compartmental model has been therefore tested against the experimental data. It was decided to estimate the four macro-constants because from the observation of the profile of the observed data it has been possible to furnish an initial adequate estimation thereof; subsequently, an indirect estimation of the four micro-constants has been determined. The results of the fitting are shown in Tab. 4.1 and in Tab. 4.2.

TABLE 4.1
Fitting results for the PK model of
the Experiment-A (macro-constants)

| | | | | | Coefficient |
|---|---|---|---|---|---|
| | | Para- | | Standard | of |
| dose | Mouse | meter | Estimate | Error | variation % |
| 20 | 0 | A | 1975.286785 | 1282.032291 | 64.90 |
| 20 | 0 | B | 128.481924 | 78.585642 | 61.16 |
| 20 | 0 | Alpha | 43.221893 | 28.328925 | 65.54 |
| 20 | 0 | Beta | 3.385737 | 1.079574 | 31.89 |
| 20 | 31 | A | 14365.650820 | 7742.553831 | 53.90 |
| 20 | 31 | B | 518.498059 | 421.512718 | 81.29 |
| 20 | 31 | Alpha | 27.018803 | 14.186754 | 52.51 |
| 20 | 31 | Beta | 4.336014 | 1.159805 | 26.75 |
| 20 | 55 | A | 27526.035314 | 14486.454863 | 52.63 |
| 20 | 55 | B | 293.519807 | 181.011539 | 61.67 |
| 20 | 55 | Alpha | 38.913212 | 14.363319 | 36.91 |
| 20 | 55 | Beta | 3.574549 | 1.023429 | 28.63 |
| 20 | 69 | A | 93311.275568 | 32662.528810 | 35.00 |
| 20 | 69 | B | 12929.572382 | 6993.496405 | 54.09 |
| 20 | 69 | Alpha | 139.064188 | 52.274192 | 37.59 |
| 20 | 69 | Beta | 20.259586 | 2.674714 | 13.20 |
| 30 | 28 | A | 54798.379413 | 18043.934110 | 32.93 |
| 30 | 28 | B | 2069.269924 | 2484.430127 | 120.06 |
| 30 | 28 | Alpha | 23.403204 | 8.581697 | 36.67 |
| 30 | 28 | Beta | 5.609578 | 1.367169 | 24.37 |
| 30 | 59 | A | 80469.811028 | 21044.798240 | 26.15 |
| 30 | 59 | B | 3.796660 | 224.278340 | 5907.25 |
| 30 | 59 | Alpha | 23.567394 | 4.550301 | 19.31 |
| 30 | 59 | Beta | 0.004217 | 11.921837 | 282693.35 |
| 30 | 64 | A | 39912.523664 | 5999.935357 | 15.03 |
| 30 | 64 | B | 374.764741 | 1054.431434 | 281.36 |
| 30 | 64 | Alpha | 17.964579 | 3.023201 | 16.83 |
| 30 | 64 | Beta | 3.308006 | 2.836746 | 85.75 |
| 30 | 88 | A | 51349.893679 | 27072.436936 | 52.72 |
| 30 | 88 | B | 591.603535 | 685.142656 | 115.81 |
| 30 | 88 | Alpha | 28.185125 | 12.674890 | 44.97 |
| 30 | 88 | Beta | 3.940800 | 1.444882 | 36.66 |
| 40 | 26 | A | 7586.088878 | 5540.588251 | 73.04 |
| 40 | 26 | B | 297.846054 | 2209.304238 | 741.76 |
| 40 | 26 | Alpha | 16.381024 | 22.831655 | 139.38 |
| 40 | 26 | Beta | 3.264913 | 7.522707 | 230.41 |
| 40 | 78 | A | 21408.348297 | 8622.976816 | 40.28 |
| 40 | 78 | B | 2.600493 | 221.281975 | 8509.23 |
| 40 | 78 | Alpha | 20.127882 | 6.571843 | 32.65 |
| 40 | 78 | Beta | 0.034770 | 18.378697 | 52857.32 |
| 40 | 80 | A | 139526.742848 | 34846.589131 | 24.97 |
| 40 | 80 | B | 31692.453321 | 5823.574947 | 18.38 |
| 40 | 80 | Alpha | 78.095566 | 23.362506 | 29.92 |
| 40 | 80 | Beta | 8.112258 | 0.385741 | 4.76 |
| 40 | 81 | A | 79738.401451 | 31751.119098 | 39.82 |
| 40 | 81 | B | 4.845376 | 2277.803037 | 47009.83 |
| 40 | 81 | Alpha | 17.278017 | 7.666394 | 44.37 |
| 40 | 81 | Beta | 0.105134 | 120.257094 | 114385.01 |

TABLE 4.2
Fitting results for the PK model of
the Experiment-A (micro-constants)

| | | Para- | | Standard | Coefficient of |
|---|---|---|---|---|---|
| | Mouse | meter | Estimate | Error | variation % |
| 20 | 0 | K10 | 25.149939 | 13.685389 | 54.42 |
| 20 | 0 | K12 | 15.639070 | 15.798001 | 101.02 |
| 20 | 0 | K21 | 5.818622 | 3.029916 | 52.07 |
| 20 | 0 | Vd | 9506.748494 | 5830.585438 | 61.33 |
| 20 | 31 | K10 | 22.854027 | 10.229239 | 44.76 |
| 20 | 31 | K12 | 3.374608 | 3.969929 | 117.64 |
| 20 | 31 | K21 | 5.126182 | 1.844689 | 35.99 |
| 20 | 31 | Vd | 1343.711365 | 711.551400 | 52.95 |
| 20 | 55 | K10 | 35.237656 | 12.855579 | 36.48 |
| 20 | 55 | K12 | 3.302703 | 2.204394 | 66.75 |
| 20 | 55 | K21 | 3.947402 | 1.220749 | 30.93 |
| 20 | 55 | Vd | 718.918757 | 374.480226 | 52.09 |
| 20 | 69 | K10 | 81.150087 | 18.685564 | 23.03 |
| 20 | 69 | K12 | 43.455513 | 33.400778 | 76.86 |
| 20 | 69 | K21 | 34.718174 | 15.025124 | 43.28 |
| 20 | 69 | Vd | 188.251510 | 56.678520 | 30.11 |
| 30 | 28 | K10 | 20.981492 | 5.577373 | 26.58 |
| 30 | 28 | K12 | 1.774247 | 2.497112 | 140.74 |
| 30 | 28 | K21 | 6.257043 | 2.231024 | 35.66 |
| 30 | 28 | Vd | 527.540708 | 176.480788 | 33.45 |
| 30 | 59 | K10 | 18.650911 | 10765.716256 | 57722.20 |
| 30 | 59 | K12 | 4.915371 | 10761.582235 | 218937.32 |
| 30 | 59 | K21 | 0.005329 | 11.987007 | 224942.58 |
| 30 | 59 | Vd | 372.793029 | 97.862763 | 26.25 |
| 30 | 64 | K10 | 17.253474 | 1.774123 | 10.28 |
| 30 | 64 | K12 | 0.574764 | 1.029971 | 179.20 |
| 30 | 64 | K21 | 3.444346 | 3.208924 | 93.16 |
| 30 | 64 | Vd | 744.651755 | 118.455697 | 15.91 |
| 30 | 88 | K10 | 26.339476 | 10.738048 | 40.77 |
| 30 | 88 | K12 | 1.569511 | 2.014807 | 128.37 |
| 30 | 88 | K21 | 4.216938 | 1.751816 | 41.54 |
| 30 | 88 | Vd | 577.572877 | 304.161601 | 52.66 |
| 40 | 26 | K10 | 14.222494 | 10.235898 | 71.97 |
| 40 | 26 | K12 | 1.663018 | 9.629206 | 579.02 |
| 40 | 26 | K21 | 3.760425 | 11.437871 | 304.16 |
| 40 | 26 | Vd | 5073.608590 | 4325.129246 | 85.25 |
| 40 | 78 | K10 | 18.807816 | 553.083821 | 2940.71 |
| 40 | 78 | K12 | 1.317626 | 547.218243 | 41530.63 |
| 40 | 78 | K21 | 0.037211 | 18.584414 | 49943.57 |
| 40 | 78 | Vd | 1868.203058 | 760.070872 | 40.68 |
| 40 | 80 | K10 | 30.073532 | 6.031163 | 20.05 |
| 40 | 80 | K12 | 35.068214 | 15.710770 | 44.80 |
| 40 | 80 | K21 | 21.066078 | 5.060230 | 24.02 |
| 40 | 80 | Vd | 233.618665 | 47.108319 | 20.16 |
| 40 | 81 | K10 | 17.108216 | 121.455316 | 709.92 |
| 40 | 81 | K12 | 0.168757 | 114.640899 | 67932.37 |
| 40 | 81 | K21 | 0.106177 | 120.740548 | 113716.21 |
| 40 | 81 | Vd | 501.609874 | 206.181557 | 41.10 |

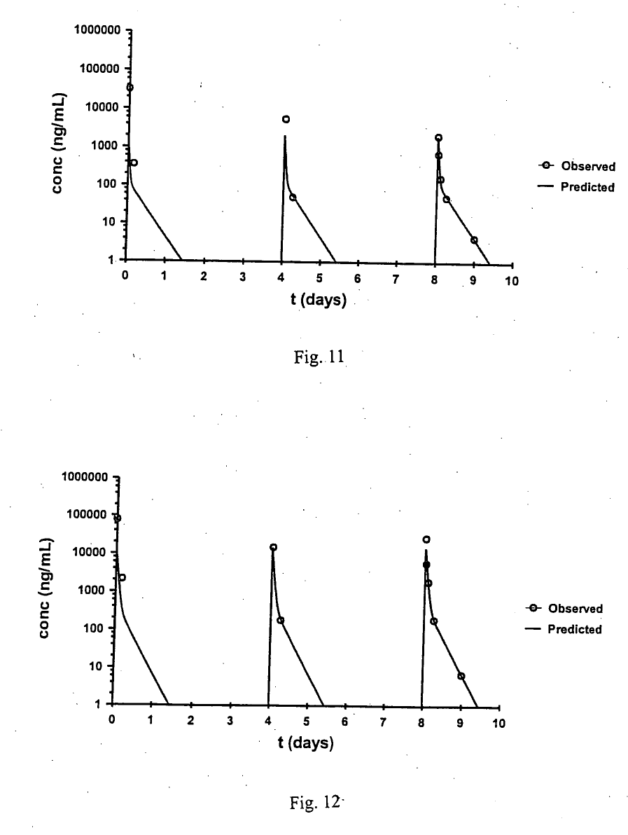

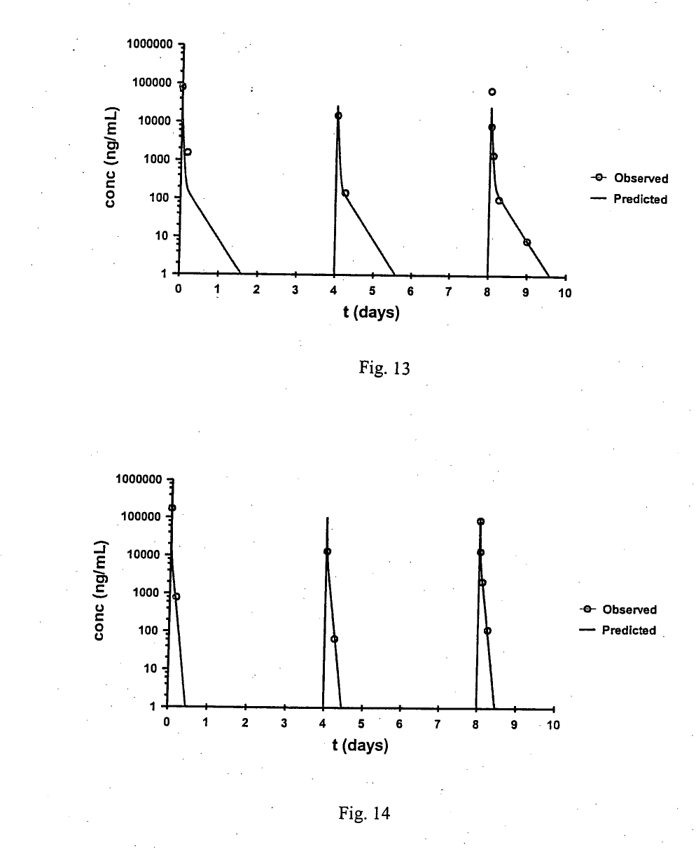

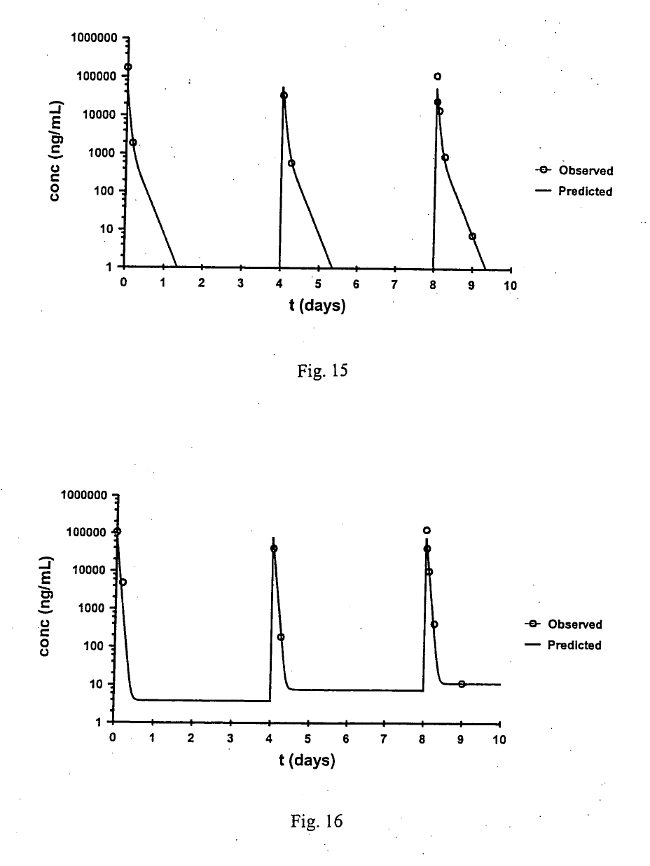

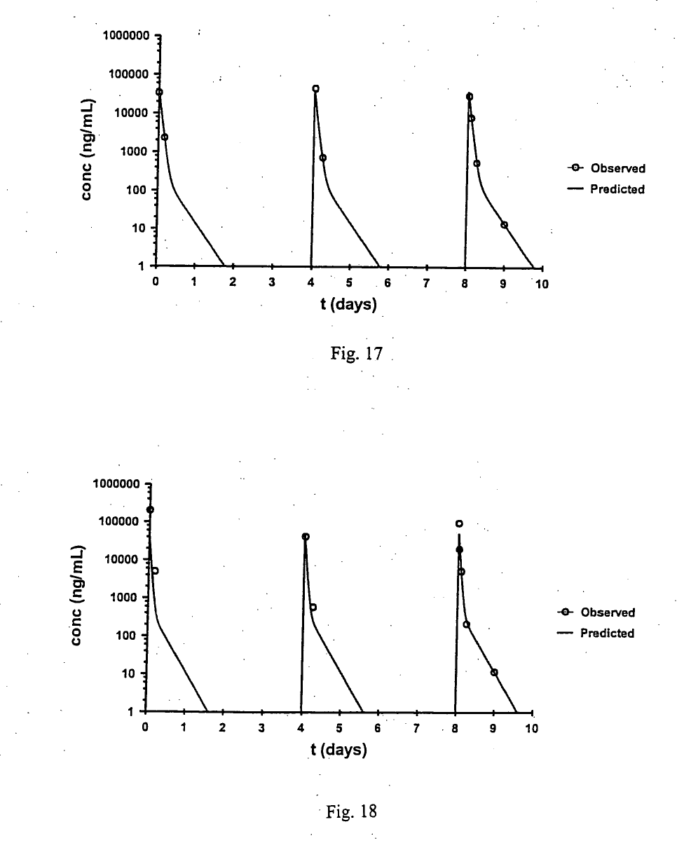

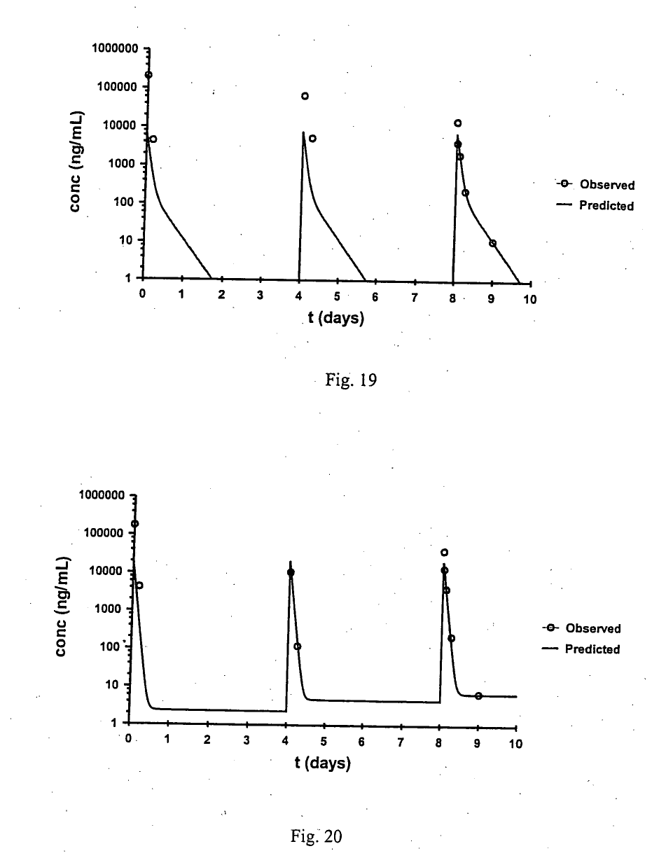

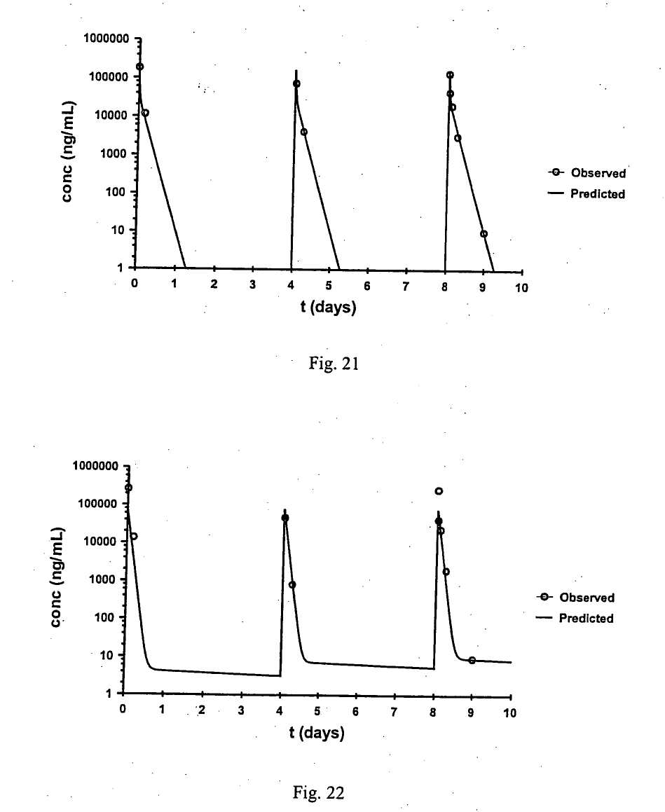

FIGS. 11-22 the concentration data have been graphically compared with the data predicted by the fitting, in a semi-logarithmic scale given the great variability in terms of order of greatness.

Descriptive statistics (mean, standard deviation and coefficient of variation) of macro and micro constants are presented in tables 4.3 and 4.4.

TABLE 4.3
PK model (macro-constants) for the Experiment-A:
descriptive statistics

| | | | | Coefficient of |
|---|---|---|---|---|
| dose | Parameter | Mean | Standard deviation | variation % |
| 20 | A | 34294.5621 | 40704.1459 | 118.6898 |
| 20 | B | 3467.5180 | 6310.0612 | 181.9763 |
| 20 | α | 62.0545 | 51.7950 | 83.4670 |
| 20 | β | 7.8890 | 8.2573 | 104.6689 |
| 30 | A | 56632.6519 | 17117.6803 | 30.2258 |
| 30 | B | 759.8587 | 906.0527 | 119.2396 |
| 30 | α | 23.2801 | 4.1798 | 17.9543 |
| 30 | β | 3.2157 | 2.3508 | 73.1045 |
| 40 | A | 62064.8954 | 60369.9313 | 97.2690 |
| 40 | B | 7999.4363 | 15795.9532 | 197.4633 |
| 40 | α | 32.9706 | 30.1257 | 91.3713 |
| 40 | β | 2.8793 | 3.8000 | 131.9778 |

TABLE 4.4
PK model (micro-constants) for the Experiment-A:
descriptive statistics

| | | | | Coefficient of |
|---|---|---|---|---|
| dose | Parameter | Mean | Standard error | variation % |
| 20 | K₁₀ | 41.0979 | 27.2378 | 66.2754 |
| 20 | K₁₂ | 16.4430 | 18.9189 | 115.0576 |
| 20 | K₂₁ | 12.4026 | 14.8971 | 120.1127 |
| 20 | Vd | 2939.4075 | 4403.6214 | 149.8132 |
| 30 | K₁₀ | 20.8063 | 3.9965 | 19.2079 |
| 30 | K₁₂ | 2.2085 | 1.8791 | 85.0862 |
| 30 | K₂₁ | 3.4809 | 2.6032 | 74.7844 |
| 30 | Vd | 555.6396 | 153.2200 | 27.5754 |
| 40 | K₁₀ | 20.0530 | 6.9433 | 34.6247 |
| 40 | K₁₂ | 9.5544 | 17.0212 | 178.1503 |
| 40 | K₂₁ | 6.2425 | 10.0343 | 160.7418 |
| 40 | Vd | 1919.2600 | 2221.3840 | 115.7417 |

The two-compartment PK model, employed for describing the pharmacokinetics of the Drug-A, allowed to get satisfactory individual results (the estimation of the four macro-constants). Only for three mice (No. 59, 78 and 81) the predicted profile of concentration seems to have an anomalous time course; in particular, a very slow phase of decay is observed (an excessively low value for the estimation of the macro-constant β). It seems obvious to suppose that such phenomenon is mainly imputable to the lack of experimental data in correspondence of the phase of elimination (related to the parameters B and β).

Considering the parameters values, a great inter-individual variability is however denoted, mainly regarding exactly the parameters B and β. In order to obtain qualitatively better estimations for such parameters, a more complete sampling scheme between the administration of an intravenous bolus and the following one, would be necessary; this is in contrast with the limitations of the physical endurance of the mice submitted to the monitoring of the plasma concentration.

Regardless of the fact that only five experimental observations were available for each mouse, rather stable individual estimations were obtained (moderately limited CV %) for all the four micro-constants, as well as a reconstruction of the concentration profile which is rather faithful to the experimental data. As a consequence, the observed inter-individual variability was rather limited for all the four micro constants.

Experiment-C: PK Model

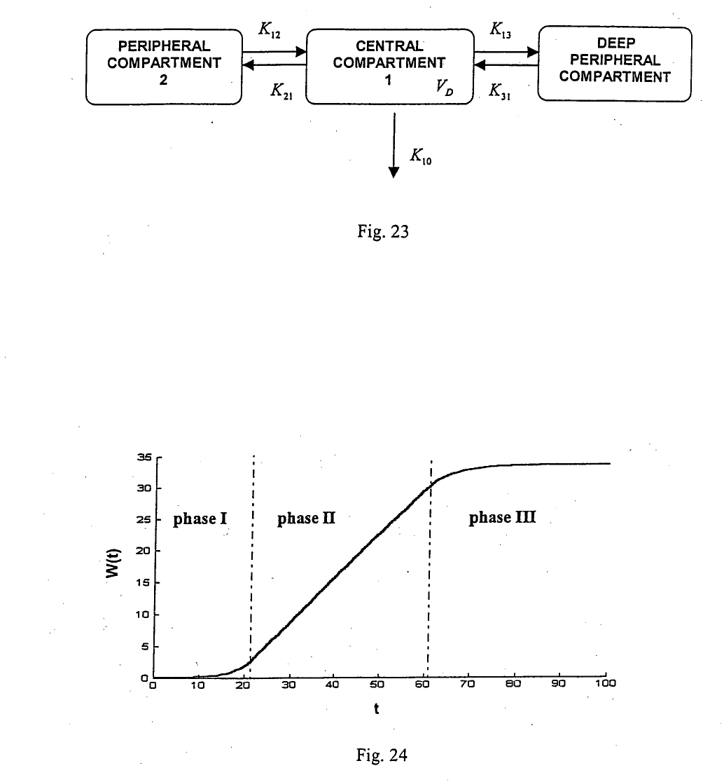

The pharmacokinetics of the Drug-C is known and can be described by a three-compartment PK model, whose characteristic micro-constants are known. The three-compartment model is an extension of the bi-compartmental model by the addition of a deep tissue compartment (FIG. 23).

A drug which requires a three-compartment model is distributed more quickly in the central compartment, less quickly in a second peripheral tissue compartment and very slowly in a third compartment, that of the deep tissues (little perfused tissues as the bones and the adipose tissues).

The average values for the six micro-constants which define the system are shown in Tab. 4.6.

TABLE 4.6
PK model for the Experiment-C: known
values of the micro-constants

| Parameter | Value | Unit |
|---|---|---|
| Vd | 181.054461 | ml/Kg |
| K10 | 134.720551 | 1/day |
| K12 | 42.326741 | 1/day |
| K13 | 13.284825 | 1/day |
| K21 | 48.69795 | 1/day |
| K31 | 5.897933 | 1/day |

Model for the Growth of the Controls

According to the present invention, the model for the growth of the controls starts from the model and equations proposed by Dagnino et al. (ditto).
Dagnino's Tumor Perfusion Model rewritten in a differential form results:

$$\begin{matrix}\frac{ⅆ W ( t )}{ⅆ t} = {λ}_{0} \cdot W ( t ) t < {t}_{1} , W ( 0 ) = {L}_{0} & ( 5.7 ) \\ \frac{ⅆ W ( t )}{ⅆ t} = {λ}_{1} t \geq {t}_{1} & ( 5.8 )\end{matrix}$$

In order to ensure W(t)εC¹, like in the previous model, the following relationship holds:
λ₀·W(t₁)=λ₁ (5.9)

A first modification to be brought to the model concerns the threshold of the passage between the phase of exponential growth and the phase of linear growth, determined by t₁. The localization of a threshold on the time scale appears inadequate for two reasons: the possible arbitrariness in the choice of the initial instant of observation and the impossibility to adequately describe the growth of the tumor if weight oscillations manifested around the value W(t₁). FIG. 24 shows a tumor Perfusion Model: a graphical representation of the differential form and determination of the weight threshold between the phase of exponential growth and the phase of linear growth.

The choice to locate a threshold related to the weight of the tumor derives from the previously described drawbacks. Such value, denoted as W*, may be easily localized in FIG. 24 or in explicit manner by the relation (5.9); accordingly:

$${W}^{*} = \frac{{λ}_{1}}{{λ}_{0}} \qquad ( 5.10 )$$

The model in differential form can then be rewritten in the following manner:

$$\begin{matrix}\begin{matrix}\frac{ⅆ W ( t )}{ⅆ t} = {λ}_{0} \cdot W ( t ) & W < {W}^{*} , W ( 0 ) = {L}_{0}\end{matrix} & ( 5.11 ) \\ \begin{matrix}\frac{ⅆ W ( t )}{ⅆ t} = {λ}_{1} & W \geq {W}^{*}\end{matrix} & ( 5.12 )\end{matrix}$$

For the sake of brevity the mathematical symbolism \dot{W} will be later adopted to denote the first derivative of the tumor weight.

Equations (5.11) and (5.12) define a function \dot{W}=f(W(t))∉C¹ and moreover the existence of a threshold, in which the growth roughly changes from an exponential profile to a linear profile, which seems poorly realistic for a physiological system; the following step consists therefore in the search of a new function f(W(t))εC¹, expressible through a unique analytical expression. The adopted solution is the following:

$$\begin{matrix}\dot{W} = \frac{{λ}_{0} \cdot W ( t )}{{[ 1 + {( \frac{{λ}_{0}}{{λ}_{1}} \cdot W ( t ) )}^{ψ} ]}^{\frac{1}{ψ}}} & W ( 0 ) = {L}_{0}\end{matrix} \qquad ( 5.13 )$$

The equation describes an exponential growth in the first phases (for small W(t)) and a linear growth for high values of W(t). The term at the denominator may be interpreted as a penalty factor of the exponential growth; from a physiological point of view then it may be conceived as an index of the incapability to develop a suitable vascular network through the mechanism of angiogenesis. In the initial phase of growth (small W(t)) the denominator can be approximated to the unity (maximum ability of induction of the angiogenesis), while as soon as W(t) increases, the denominator grows up to approximate the value W(t)^{·λ}₀/λ₁ in correspondence of which the maximum incapability of perfusion is observed, with consequent degradation to a linear growth of the tumor mass.

Parameters of the Model

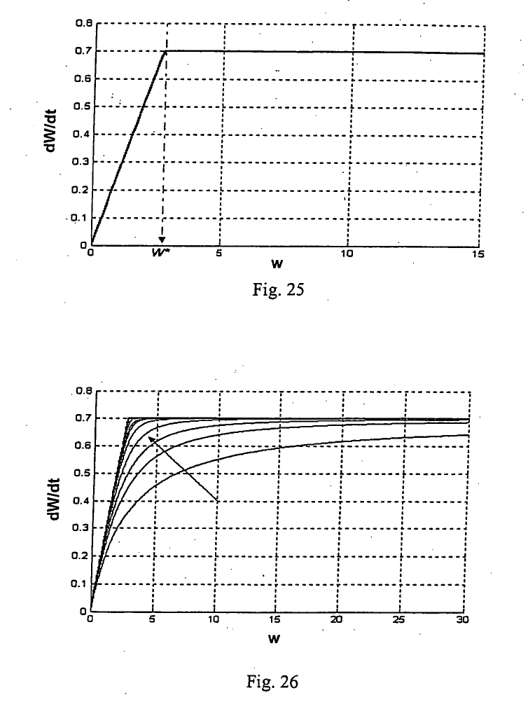

The model for the growth of the controls described by the equation (5.13) defines a family of function in the class C¹, parametric with respect to the choice of the parameter Ψ, of more squared shape (hence similar to that described by the Tumor Perfusion Model in differential form) with the increasing of such parameter (for this purpose, see FIG. 25) and requires the use of four parameters (L₀, λ₀, λ₁ and Ψ), individually analyzed hereafter.

I. L₀: it represents the portion of the tumor cells present at the instant t₀=0 that succeeds in taking root and in starting the tumor cells proliferation in the mammals. A great inter-individual variability is expected with respect to its value; this is due both to the lack of weight experimental data during the silent period and to the variability in relationship with the survival of the tumor cells during the inoculum. Dimensionally it represents a weight and therefore it is expressed in [weight].

II. λ₀: it represents an index of the production rate of the tumor cells during an exponential phase of the tumor growth; in other words, it is the rate of production of new tumor cells and therefore an index of the speed of completion of the cell cycle. An estimation with a low inter-individual variability is expected since its value is related to the particular cell line. Dimensionally it represents the inverse of a time and therefore it is expressed in [time⁻¹].

III. λ₁: it represents an index of the tumor cells mass produced in the time unit during a linear phase of the tumor growth; unlike λ₀, an obvious inter-individual variability is expected from its estimation since it is related to the capability of the single treated subject to develop a vascular network sufficient for the perfusion of the tumor. Dimensionally expressed in [weighttime⁻¹].

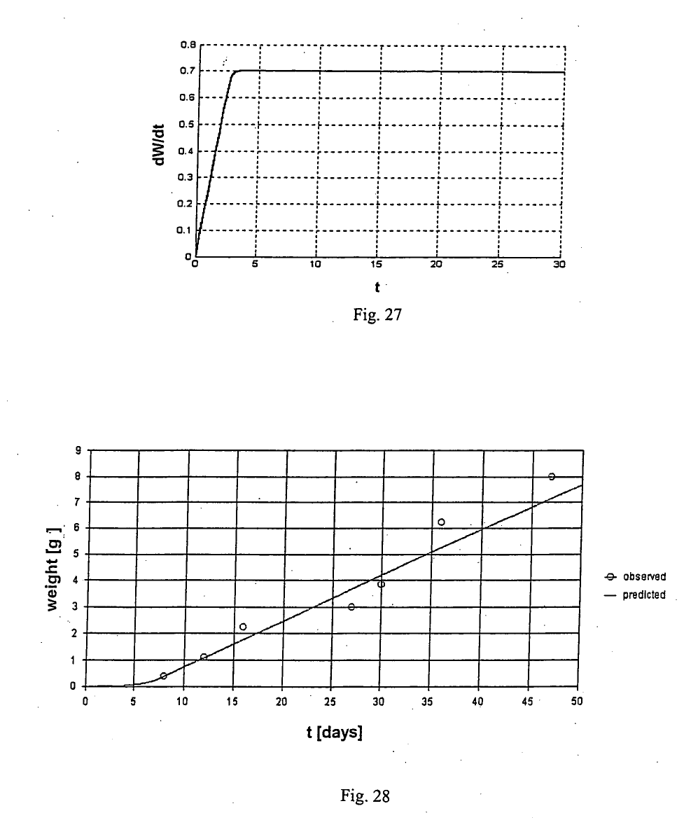

IV. Ψ: it represents an adimensional “shape” parameter of the curve described by the model in differential form. Its value will not be estimated both in order to avoid making difficulties in the fitting procedure from a numerical point of view, and because the profile of the function \dot{W}, if sufficiently squared, does not affect the quality of the fitting. A somehow arbitrary value will be then fixed, Ψ=20 (FIG. 27), which gave good results in terms of fitting and in correspondence of which the time course of \dot{W} has the profile shown in FIG. 26. The fitting of the curve described by (5.13) against the available set of experimental data for the controls was performed in the two experiments, using the WLS as above described.

Experiment-A: Fitting of the Controls

Results of the individual fitting for each of the eight mice belonging to the control group are shown in Tab. 5.1.

TABLE 5.1
Growth model for the controls: fitting
results for the Experiment-A

| | | | | Coefficient of |
|---|---|---|---|---|
| Mouse | Parameter | Estimate | Standard Error | variation % |
| 18 | L₀ | 0.045016 | 0.014419 | 32.03 |
| 18 | λ₀ | 0.268628 | 0.033210 | 12.36 |
| 18 | λ₁ | 0.258402 | 0.013803 | 5.34 |
| 27 | L₀ | 0.070632 | 0.037317 | 52.83 |
| 27 | λ₀ | 0.202294 | 0.047203 | 2333 |
| 27 | λ₁ | 0.241229 | 0.032812 | 13.60 |
| 52 | L₀ | 0.035615 | 0.029444 | 82.67 |
| 52 | λ₀ | 0.278386 | 0.087878 | 31.57 |
| 52 | λ₁ | 0.214820 | 0.025879 | 12.05 |
| 58 | L₀ | 0.062055 | 0.013369 | 21.54 |
| 58 | λ₀ | 0.191069 | 0.019411 | 10.16 |
| 58 | λ₁ | 0.174875 | 0.011571 | 6.62 |
| 71 | L₀ | 0.075413 | 0.024197 | 32.09 |
| 71 | λ₀ | 0.176932 | 0.026338 | 14.89 |
| 71 | λ₁ | 0.202956 | 0.026063 | 12.84 |
| 77 | L₀ | 0.051292 | 0.010218 | 19.92 |
| 77 | λ₀ | 0.217785 | 0.018820 | 8.64 |
| 77 | λ₁ | 0.192999 | 0.009517 | 4.93 |
| 84 | L₀ | 0.030108 | 0.007293 | 24.22 |
| 84 | λ₀ | 0.254057 | 0.023743 | 9.35 |
| 84 | λ₁ | 0.162836 | 0.007744 | 4.76 |
| 86 | L₀ | 0.000784 | 0.028757 | 3667.98 |
| 86 | λ₀ | 0.749918 | 2.728817 | 363.88 |
| 86 | λ₁ | 0.178893 | 0.012483 | 6.98 |

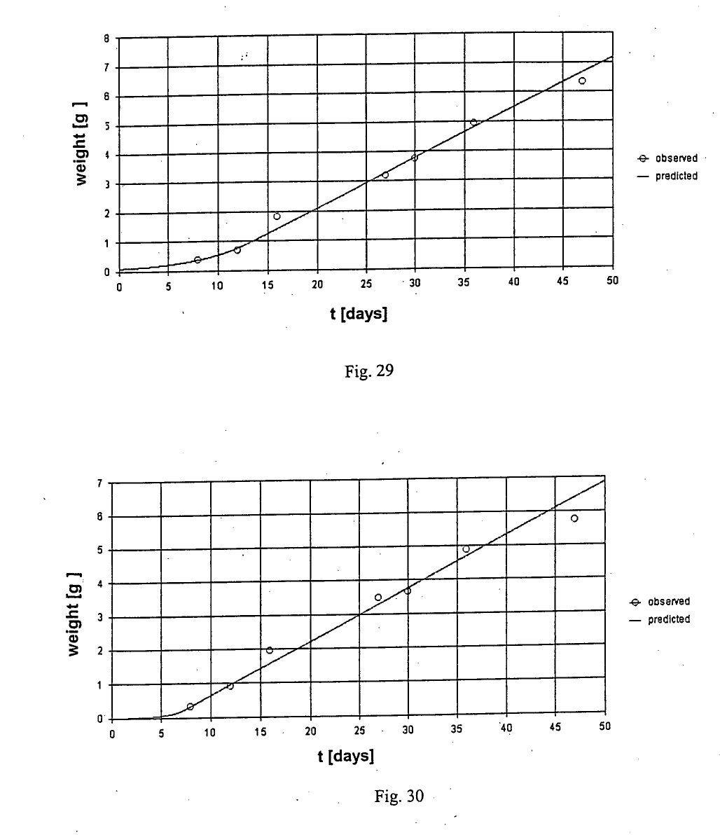

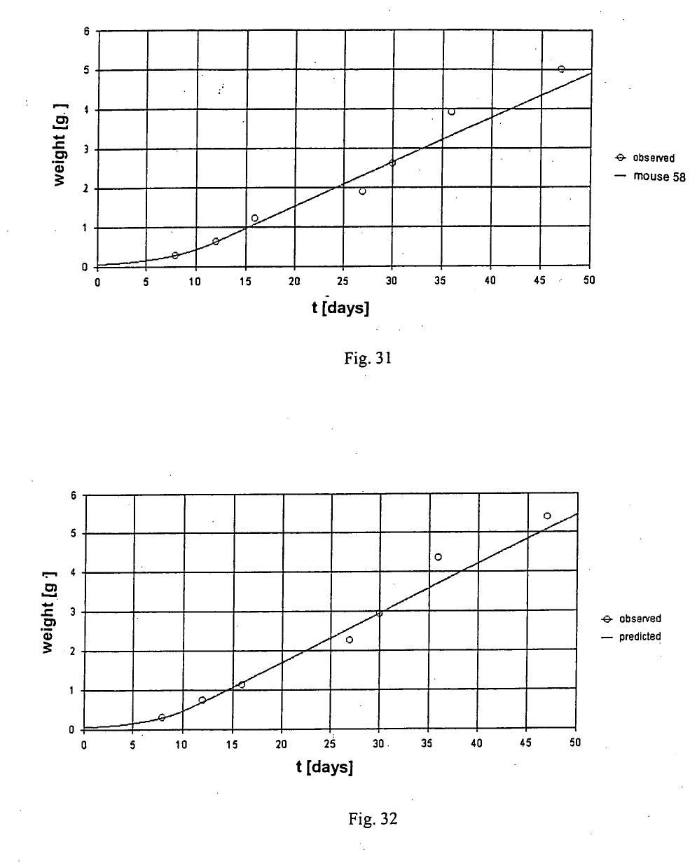

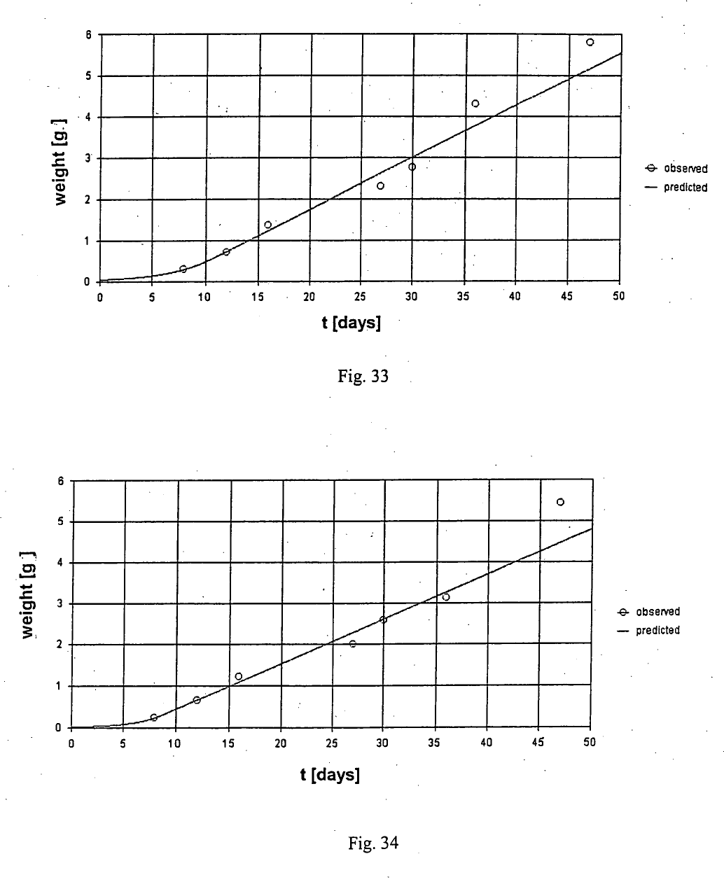

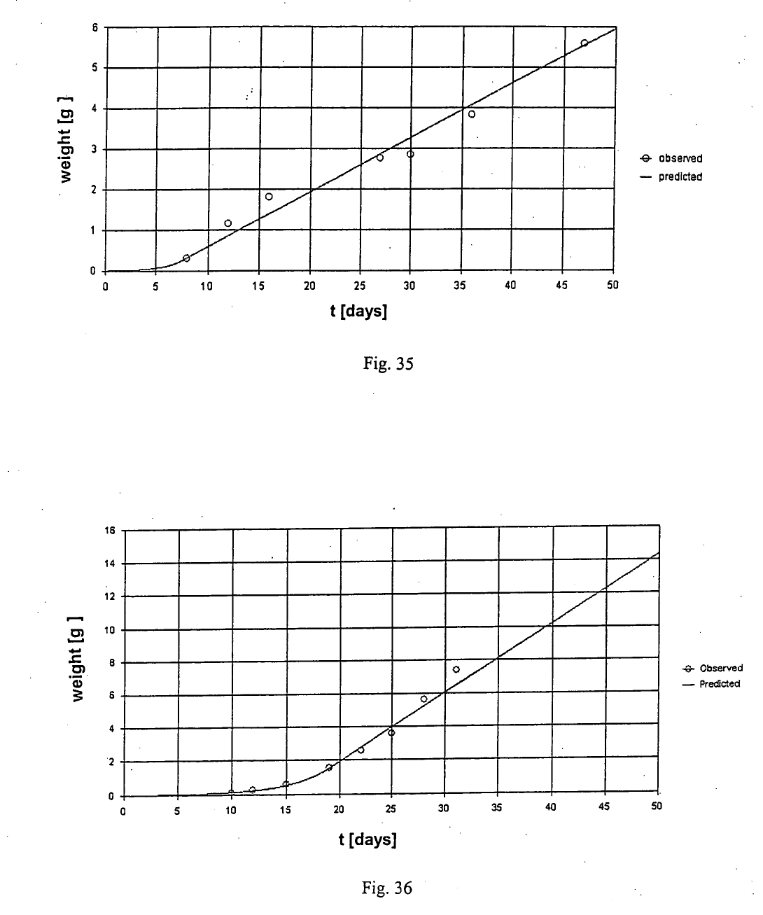

FIGS. 28-35 show the tumor weight data and the data predicted by the model for the eight mice of G1.

Descriptive statistics (mean, standard deviation and coefficient of variation) of the three parameters are shown in Tab. 5.2.

TABLE 5.2
Growth model for the controls of the
Experiment-A: descriptive statistics

| Parameter | Mean | Standard Error | Coefficient of variation % |
|---|---|---|---|
| L₀ | 0.046400 | 0.024400 | 52.59 |
| λ₀ | 0.292400 | 0.188500 | 34.49 |
| λ₁ | 0.203400 | 0.033300 | 16.37 |

Experiment-C: Fitting of the Controls

The results of the fitting performed on mean value of tumor weight, of the mice belonging to the cage G1, are shown in Tab. 5.5. FIG. 36 shows a graphical representation of the observed mean value and the relating one predicted by the fitting.

TABLE 5.5
Growth model for the controls: fitting
results for the Experiment-C

| Parameter | Estimate | Standard Error | Coefficient of variation % |
|---|---|---|---|
| L₀ | 0.009921 | 0.002702 | 27.24 |
| λ₀ | 0.265072 | 0.018880 | 7.12 |
| λ₁ | 0.413506 | 0.052923 | 12.80 |

The model proposed for describing the unperturbed growth of the tumor provided encouraging results in terms of fitting; despite the limited number of available experimental observations for all the subjects, the individual estimations allow to describe the experimental curve of growth in adequate way. The estimations of the parameters are also rather stable (rather limited CV %) with the only exception represented by the mouse number 86 of the experiment-A. Moreover, the expectations of the difficulty in the estimation of the parameter L₀ were respected: in almost the totality of cases, L₀ was the parameter with the highest values of CV %, besides stressing the greatest inter-individual variability (see the CVs in the population estimations). The experimental data were not indeed available before about a week from the inoculum of the tumor line and furthermore the behavior of the tumor during the silent period is anything but known (even at macroscopic level). The difficulties in the estimation of such parameter can be explained because the model hypothesizes an exponential growth for such period, that is extrapolated backward, from the first available measurements, during the phase of fitting.

Also the expectations of the inter-individual variability in the estimation of the parameters λ₀ and λ₁ were respected. While the former is the most stable parameter, with the smallest range of estimated values, since it is in relation with the characteristic inoculated cell line, the latter shows an evident inter-individual variability because it is mainly related to a subjective process (the angiogenesis) and therefore to the capability of each subject to extend, the phase of exponential growth rather than to make it degrade to a linear phase of growth.

Model for the Growth of Treated Subjects: Hypotheses

Before inspecting the various steps of synthesis of the model, it is necessary to introduce some simplifying hypotheses:
I. The tumor mass is considered as a homogeneous population of cells, not only from the point of view of the ability to proliferate, but also from the point of view of the susceptibility to the pharmacological treatment;
II. The diffusion of the drug is spatially uniform;
III. In the absence of chemotherapeutic treatment the tumor mass is already regulated by the equation of growth of the controls, defined by the equation (5.13).

As in the case of the model for the unperturbed growth of the tumor, the heterogeneities of the population, from the spatial point of view (position inside the tumor spheroid), and of the age (phases of the cell cycle), will not be considered with the consequent assumption that both the nutrients and the drug are able to reach all the neoplastic cells in the same manner.

Pharmacodynamic Effect

The therapeutic activity of antitumor drugs can be exerted in different ways, but all have the same principal purpose: the reduction (the elimination in some cases) of the cell pathogenous population. This purpose can be achieved either reducing the rate of growth of the population or increasing that of mortality. Independently from the nature of the drug (cytotoxic or cytostatic agent), the drug detectable effect, caused by the mechanism of action thereof is the reduction of the effective rate of growth. It is herein assumed that the chemotherapeutic treatment acts by increasing the mortality of the tumor cells (a typical mechanism of action of cytotoxic agents), modeling a perturbation to the unperturbed tumor growth kinetics through the introduction of a term of loss in the equation (5.13). The action of the chemotherapeutic agent leads to the introduction in the (5.13) of a negative term, proportional both to Z₁(t), defined as the tumor mass “damageable” by the drug action, and to the concentration of the tested compound c(t) through the constant K₂. The equation which regulates the growth of Z₁(t) can be then rewritten in the following way:
\dot{Z}₁(t)=f(W(t))−K₂·c(t)·Z₁(t) (6.1)
wherein f(W(t)) represents the equation of the growth of the controls, function of the total weight W(t).

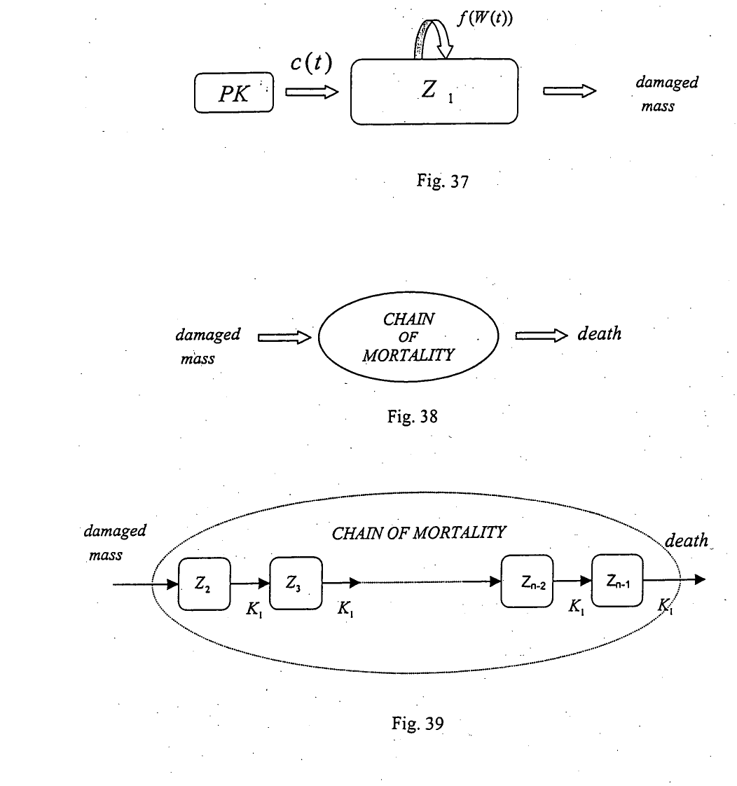

For better understanding the pharmacodynamic effect, a functional scheme was used adopting a symbolism similar to that used for the compartmental pharmacokinetic (FIG. 37). The compartment described by the variable Z₁(t) represents, in the scheme, the reproductive mass susceptible to the action of the drug through the concentration c(t). The compartment will have, in the unity of time, a rate of growth regulated by the function f(W(t)) and a rate of loss corresponding to the cells damaged by the drug.

The action of the drug is irreversible: the tumor mass, damaged by the chemotherapeutic treatment is no more able to proliferate, leaves the reproducing compartment and, after a certain time delay will die.

Chain of Mortality

The model described by the expression (6.1) involves however that the loss of weight, following the action of the drug, occurs instantaneously. On the contrary, it seems logic thinking that between the instant in which a certain cell is hit and damaged by the drug and the instant in which the cell turns out to be dissolved from the original tumor mass, a finite period of time elapses, necessary to the completion of the mechanism of action and to the decomposition of the damaged mass (because of macrophagous organisms, for instance). In order to avoid any ambiguity it has to be considered that the term “death” refers herein to the instant in which the cell will not furnish its own contribution anymore in terms of weight to the whole tumor mass.

In the developed model, it is hypothesized that the damaged tumor mass enters a “chain of mortality” from which it will exit only when death occurs; up to such event, the mass inside the chain provides a contribution to the total weight of the tumor. The permanence in this chain can be interpreted as the succeeding of stages of progressive degradation, consequent to the aggression of the drug (FIG. 38). The time of permanence inside the chain is described through a random variable =96 for which a probability density function pdf(τ) with a bell profile is hypothesized.

The required pdf(τ) may be achieved through the application of the following compartmental approach: consider n-1 compartments with first-order kinetics, regulated by the elimination constant rate K₁ (i.e. an index of the tumor cells death rate) and with state variable Zᵢ (i=2, . . . , n-1). The output of the generic compartment Zᵢ constitutes the input for the following compartment Zᵢ₊₁, with reference to FIG. 39, the first compartment receives—as an input—the tumor mass damaged in the unity of time, while the output of the last compartment represents the tumor mass dead in the unity of time.

It is possible for the described compartimental model to write the following differential equations, under the hypothesis that the mass in exit in the unity of time from a generic compartment is proportional to the resident mass according to the elimination constant rate K₁ (first-order kinetics):
\dot{Z}₂(t)=K₂·c(t)·Z₁(t)−K₁·Z₂(t)
\dot{Z}₃(t)=K₁·Z₂(t)−K₁·Z₃(t) (6.2)
\dot{Z}ᵢ(t)=K₁·Zᵢ₋₁(t)−K₁·Zₙ(t)
wherein Zᵢ(t), i, t, n, K₁ and K₂ are as above defined.

The system of equations (6.2) is characterized by an impulse response which coincides with the probability density function of the random variable τ, the survival time of a damaged cell. The pdf(τ) so obtained is Erlang(n-1, K₁):

$$pdf ( τ ) = \begin{matrix}{K}_{1} \cdot exp ( - {K}_{1} \cdot t ) \cdot \frac{{( {K}_{1} \cdot t )}^{n - 2}}{( n - 2 ) !} & t = 0 \\ 0 & otherwise\end{matrix} \qquad ( 6.4 )$$

wherein K₁, t and n are as above defined;
the mean value E[τ] and variance Var[τ] of the survival time τ resulting, respectively, from:

$$\begin{matrix}E [ τ ] = \frac{n - 1}{{K}_{1}} & ( 6.5 ) \\ Var [ τ ] = \frac{n - 1}{{K}_{1}^{2}} & ( 6.13 )\end{matrix}$$

wherein K₁ and n are as above defined;
the related function of cumulative probability distribution resulting from:

$$F ( t ) = P ( τ \leq t ) = \{ \begin{matrix}1 - {\sum }_{j = 0}^{n - 2} exp ( - {K}_{1} t ) \frac{{( {K}_{1} t )}^{j}}{j !} & t \geq 0 \\ 0 & otherwise\end{matrix} \qquad ( 6.14 )$$

wherein F(t) represents the probability that the survival time τ of a damaged cell is less than a specified time t and K₁, j (ranging from 0 to n-2), t and n are as above defined. The expression (6.14) provides the probability that the survival time τ of a damaged cell is less than a specified time t, that is the cell is already dead at the same time t. The term 1-F(t) provides, as a consequence, the probability that a damaged cell is already inside the chain of mortality.

Accordingly, it may be concluded that the convolution integral between the expression (6.4) and the input K₂·c(t)^{·}Z₁(t) provides the amount of tumor mass which dies in the unity of time.

Model for the tumor Growth in Presence of a Treatment

The overall tumor mass is constituted by the set of cells not damaged by the pharmacological action (able to proliferate according to the equation of growth of the controls) and the set of cells in transit inside the chain of mortality. The overall weight W(t) can be described by the following relationship:

$$W ( t ) = {\sum }_{i = 1}^{n} {Z}_{i} ( t ) \qquad ( 6.6 )$$

Recalling the equation (5.13), descriptive of the growth of the controls and as underlined in the “chain of mortality” section hereabove, the expression present at the denominator represents a penalty term of the exponential growth of the tumor mass. The damaged tumor mass, even if not participating in the proliferation, contributes to the overall weight since not yet dissolved and should be therefore comprehensive not only of the proliferating mass but of the whole tumor mass; on this ground, the equation (6.1) has to be therefore rewritten in the following way:

$${\dot{Z}}_{1} = \frac{{λ}_{0} \cdot {Z}_{1} ( t )}{{[ 1 + {( \frac{{λ}_{0}}{{λ}_{1}} \cdot W ( t ) )}^{ψ} ]}^{\frac{1}{ψ}}} - {K}_{2} \cdot c ( t ) \cdot {Z}_{1} ( t ) \qquad ( 6.7 )$$

The number of compartments inside the chain of mortality in this model was fixed to three. Three compartments inside the chain were sufficient to guarantee a probability density function, having a bell-like shape, of the random variable X and provided also satisfactory results in terms of fitting.

The physiological interpretation of a chain of mortality made of three compartments consists of imagining the “cellular death” event as if it was made discretized in three stages of progressive and irreversible deterioration (the possibility of recovery does not exist), low, medium and high damage which precede the effective death.

Accordingly, the model of tumor growth in vivo can be described by a system of four ordinary differential equations (6.8-6.11′), by the expression (6.6) and by the initial conditions four variables associated to the compartments (zero initial mass for the compartments inside the chain of mortality, L₀ for the proliferating compartment):

$$\begin{matrix}{\dot{Z}}_{1} = \frac{{λ}_{0} \cdot {Z}_{1} ( t )}{{[ 1 + {( \frac{{λ}_{0}}{{λ}_{1}} \cdot W ( t ) )}^{ψ} ]}^{\frac{1}{ψ}}} - {K}_{2} \cdot c ( t ) \cdot {Z}_{1} ( t ) & {Z}_{1} ( 0 ) = {L}_{0}\end{matrix} \qquad ( 6.8 )$$

\dot{Z}₂(t)=K₂·c(t)·Z₁(t)−K₁·Z₂(t) Z₂(0)=0 (6.9)
\dot{Z}₃(t)=K₁·Z₂(t)−K₁·Z₃(t) Z₃(0)=0 (6.10)
\dot{Z}₄(t)=K₁·Z₃(t)−K₁·Z₄(t) Z₄(0)=o (6.11′)
W(t)=Z₁(t)+Z₂(t)+₃(t)+Z₄(t) (6.12)

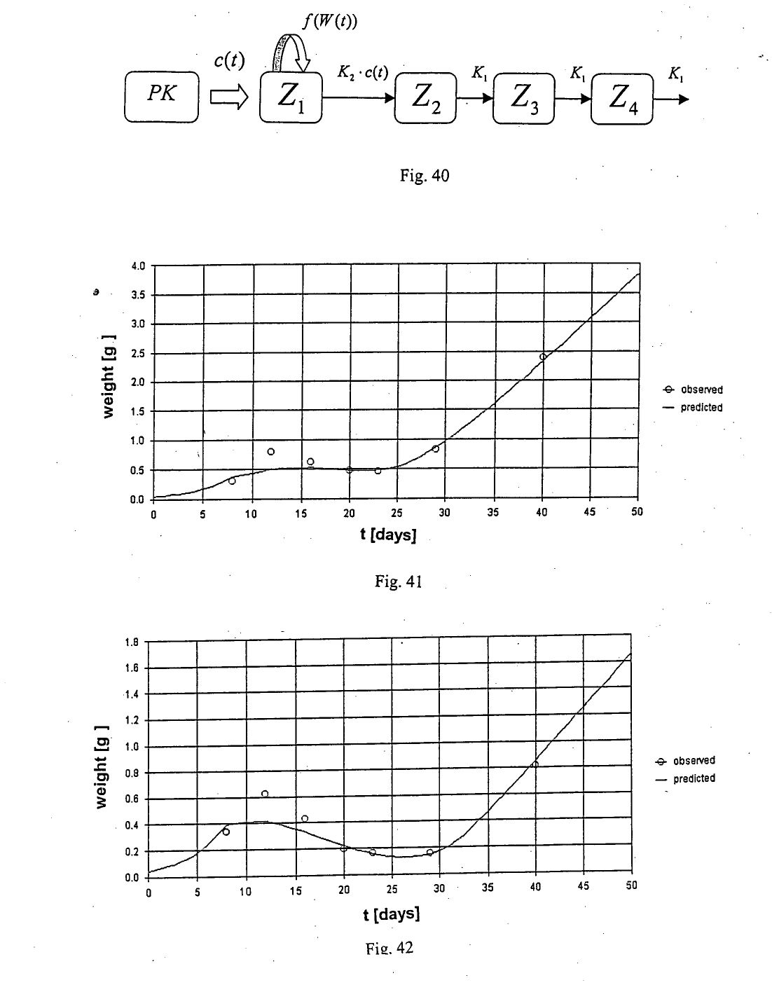

In FIG. 40 a summary scheme of the presented model is shown.

Parameters of the Model

The model of growth for the treated subjects, described by the equations (6.8-6.12) requires the use of two further parameters with respect to the four ones adopted in the model for the growth of the controls: K₁ and K₂ where:

K₁ is the parameter which determines the probability density function of the random variable τ, providing indication on the delay between the aggression of the drug and the following cell death. Having fixed the number of compartments inside the chain of mortality, the value of K₁ determines in univocal way the time course of the distribution Erlang(3, K₁) and, as a consequence, the mean value and the variance of the survival time τ. Dimensionally it represents the inverse of a time, expressed therefore in [day⁻¹]; and

K₂ is an index of the capability of the drug to hit and damage tumor cells. It is peculiar of the adopted drug and not of the treated subject. Dimensionally it represents the inverse of a concentration in the unity of time, therefore expressed in [ml g⁻¹ day⁻¹].

In analyzing the experiments A and C, the parameter L₀ was not estimated; for each experiment, it was fixed to the average value derived from the control group of each experiment. The values fixed for the two experiments are reported in Tab. 6.1

TABLE 6.1
Fixed values for the parameter L₀

| Experiment | L₀ |
|---|---|
| A | 0.046400 |
| C | 0.009921 |

The shape parameter Ψ remains fixed as in the case of the controls to the value Ψ=20.

Altogether the model of growth in the presence of the drug requires the estimation of the parameters λ₀, λ₁, K₁ and K₂.

The fitting of the curve described by the expression (6.8-6.12) was performed, using the set experimental data available for the treated mice in the two experiments A and C, employing the weighted least squares (WLS) as described hereinabove.

Experiment-A: Fitting of the Treated Subjects

The results of the individual fitting for each of the twelve treated mice are shown in Tab. 6.2 and Tab. 6.3. Descriptive statistics (mean, standard deviation and coefficient of variation) of the pharmacodynamic parameters are presented in table 6.4.

TABLE 6.2
Model for the growth of treated subjects: fitting
results of the Experiment-A (1st part)

| | | | | Coefficient of |
|---|---|---|---|---|
| Mouse | Parameter | Estimate | Standard Error | variation % |
| 0 | K1 | 0.205728 | 0.159013 | 77.29 |
| 0 | K2 | 0.018783 | 0.004740 | 25.24 |
| 0 | LAMBDA0 | 0.260052 | 0.022622 | 8.70 |
| 0 | LAMBDA1 | 0.156333 | 0.085412 | 54.63 |
| 26 | K1 | 0.165817 | 0.092748 | 55.93 |
| 26 | K2 | 0.003150 | 0.000741 | 23.51 |
| 26 | LAMBDA0 | 0.208661 | 0.017540 | 8.41 |
| 26 | LAMBDA1 | 0.167755 | 0.590824 | 352.19 |
| 28 | K1 | 0.140555 | 0.041659 | 29.64 |
| 28 | K2 | 0.000759 | 0.000087 | 11.42 |
| 28 | LAMBDA0 | 0.239634 | 0.007026 | 2.93 |
| 28 | LAMBDA1 | 0.160017 | 0.112390 | 70.24 |
| 31 | K1 | 0.268318 | 0.038825 | 14.47 |
| 31 | K2 | 0.003356 | 0.000474 | 14.13 |
| 31 | LAMBDA0 | 0.272636 | 0.051738 | 18.98 |
| 31 | LAMBDA1 | 0.080947 | 0.038358 | 47.39 |
| 55 | K1 | 0.242353 | 0.031987 | 13.20 |
| 55 | K2 | 0.002721 | 0.000481 | 17.67 |
| 55 | LAMBDA0 | 0.237715 | 0.024407 | 10.27 |
| 55 | LAMBDA1 | 0.072226 | 0.045052 | 62.38 |
| 59 | K1 | 0.191979 | 0.078985 | 41.14 |
| 59 | K2 | 0.000563 | 0.000279 | 49.52 |
| 59 | LAMBDA0 | 0.245782 | 0.050772 | 20.66 |
| 59 | LAMBDA1 | 0.072748 | 0.062323 | 85.67 |

TABLE 6.3
Model for the growth of treated subjects: fitting
results of the Experiment-A (2nd part)

| | | | | Coefficient of |
|---|---|---|---|---|
| Mouse | Parameter | Estimate | Standard Error | variation % |
| 64 | K₁ | 0.164603 | 0.123634 | 75.11 |
| 64 | K₂ | 0.001085 | 0.000723 | 66.66 |
| 64 | λ₀ | 0.256492 | 0.026476 | 10.32 |
| 64 | λ₁ | 0.179993 | 1.045608 | 580.92 |
| 69 | K₁ | 0.151520 | 0.079458 | 52.44 |
| 69 | K₂ | 0.001361 | 0.000188 | 13.81 |
| 69 | λ₀ | 0.246427 | 0.015494 | 6.29 |
| 69 | λ₁ | 0.178159 | 0.074584 | 41.86 |
| 78 | K₁ | 0.205620 | 0.061689 | 30.00 |
| 78 | K₂ | 0.001507 | 0.000163 | 10.79 |
| 78 | λ₀ | 0.243797 | 0.014687 | 6.02 |
| 78 | λ₁ | 0.127560 | 0.033951 | 26.62 |
| 80 | K₁ | 0.209036 | 0.198231 | 94.83 |
| 80 | K₂ | 0.000178 | 0.000190 | 106.67 |
| 80 | λ₀ | 0.233978 | 0.030732 | 13.13 |
| 80 | λ₁ | 0.059851 | 0.045007 | 75.20 |
| 81 | K₁ | 0.220589 | 0.081270 | 36.84 |
| 81 | K₂ | 0.000314 | 0.000145 | 46.25 |
| 81 | λ₀ | 0.272345 | 0.045481 | 16.70 |
| 81 | λ₁ | 0.068504 | 0.027110 | 39.57 |
| 88 | K₁ | 0.088191 | 0.169422 | 192.11 |
| 88 | K₂ | 0.001276 | 0.001443 | 113.04 |
| 88 | λ₀ | 0.243130 | 0.029906 | 12.30 |
| 88 | λ₁ | 0.204867 | 1.284623 | 627.05 |

TABLE 6.4
Model for the growth of treated subjects of
the Experiment-A: descriptive statistics

| Parameter | Mean | Standard Error | Coefficient of variation % |
|---|---|---|---|
| K1 | 0.187859 | 0.048742 | 25.95 |
| K2 | 0.002921 | 0.005107 | 174.85 |
| λ₀ | 0.246721 | 0.017493 | 7.09 |
| λ₁ | 0.127413 | 0.053167 | 41.73 |

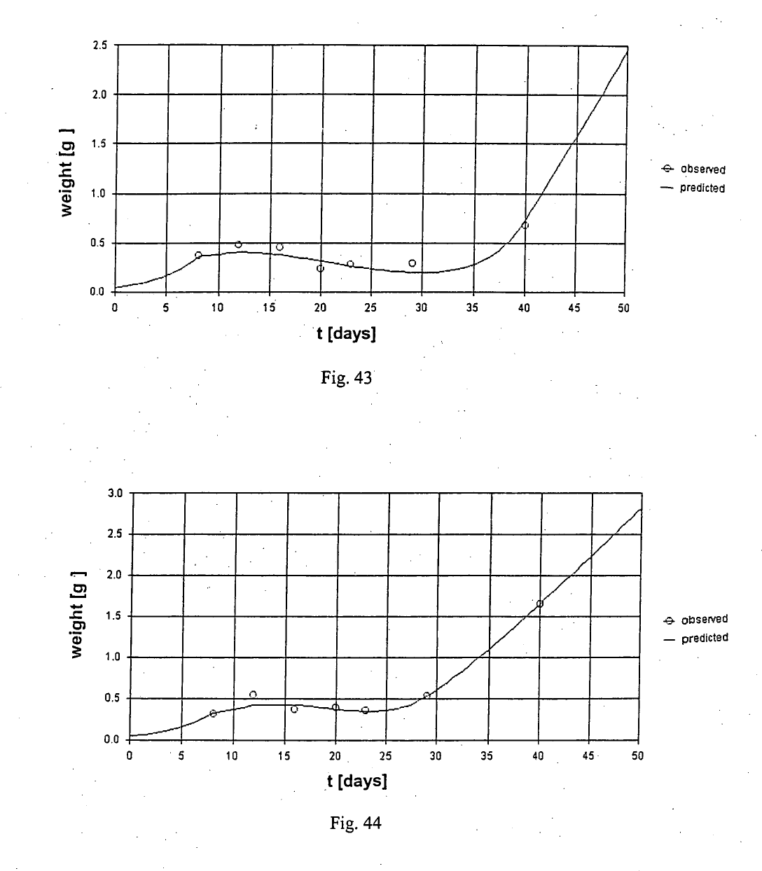

The results were then represented graphically in order to compare the observed experimental values of the tumor weight with those predicted by the fitting. Only the results related to four mice (0, 31, 64, 78) of the Experiment-A were represented (see FIGS. 41-44). The proposed model provides good results in terms of fitting. The predicted values appear sufficiently descriptive of the available experimental data, in particular, in the phase of re-growth after the treatment. Nevertheless, a certain difficulty to represent the tumor growth curve can be observed in the instants immediately after the first pharmacological treatment. Considering that for Experiment-A the treatment began in correspondence of the first experimental observation (the eighth day), the incapability of the predicted curve to approach the second experimental observation (taken in correspondence of the twelfth day) was observed. This aspect was also underlined in the following experiment C, performed in order to provide an alternative solution suitable to describe more properly all the phases of growth.

Experiment-C: Fitting of the Treated Subjects

The estimations of the four parameters of the model related to each of the nine groups of treatment (G2-G10) were computed by the fitting performed on the average curves of growth; the obtained results are shown in Tab. 6.7, while the population values are shown in Tab 6.8.

TABLE 6.7
Model for the growth of treated subjects:
fitting results of the Experiment-C

| | | | | Coefficient of |
|---|---|---|---|---|
| Cage | Parameter | Estimate | Standard Error | variation % |
| G2 | K₁ | 0.288971 | 0.035080 | 12.14 |
| G2 | K₂ | 0.173108 | 0.012674 | 7.32 |
| G2 | λ₀ | 0.288574 | 0.014569 | 5.05 |
| G2 | λ₁ | 0.518332 | 0.204345 | 39.42 |
| G3 | K₁ | 0.257410 | 0.019121 | 7.43 |
| G3 | K₂ | 0.151862 | 0.009861 | 6.49 |
| G3 | λ₀ | 0.275729 | 0.012817 | 4.65 |
| G3 | λ₁ | 0.624120 | 0.220061 | 35.26 |
| G4 | K₁ | 0.255818 | 0.017749 | 6.94 |
| G4 | K₂ | 0.108539 | 0.009525 | 8.78 |
| G4 | λ₀ | 0.229675 | 0.015908 | 6.93 |
| G4 | λ₁ | 0.319260 | 0.156537 | 49.03 |
| G5 | K₁ | 0.297882 | 0.043048 | 14.45 |
| G5 | K₂ | 0.204378 | 0.007507 | 3.67 |
| G5 | λ₀ | 0.272797 | 0.009207 | 3.37 |
| G5 | λ₁ | 0.602027 | 0.005416 | 0.90 |
| G6 | K₁ | 0.348589 | 0.023994 | 6.88 |
| G6 | K₂ | 0.169793 | 0.004150 | 2.44 |
| G6 | λ₀ | 0.255437 | 0.012336 | 4.83 |
| G6 | λ₁ | 0.273612 | 0.056692 | 20.72 |
| G7 | K₁ | 0.248832 | 0.057426 | 23.08 |
| G7 | K₂ | 0.119964 | 0.068676 | 57.25 |
| G7 | λ₀ | 0.196622 | 0.003709 | 1.89 |
| G7 | λ₁ | 0.279020 | 0.245275 | 87.91 |
| G8 | K₁ | 0.376555 | 0.157289 | 41.77 |
| G8 | K₂ | 0.208072 | 0.028950 | 13.91 |
| G8 | λ₀ | 0.261113 | 0.026221 | 10.04 |
| G8 | λ₁ | 0.581044 | 0.012493 | 2.15 |
| G9 | K₁ | 0.415248 | 0.315054 | 75.87 |
| G9 | K₂ | 0.282864 | 0.000040 | 0.01 |
| G9 | λ₀ | 0.294232 | 0.006464 | 2.20 |
| G9 | λ₁ | 0.193089 | 0.011947 | 6.19 |
| G10 | K₁ | 0.378929 | 0.623717 | 164.60 |
| G10 | K₂ | 0.155760 | 0.069571 | 44.67 |
| G10 | λ₀ | 0.296947 | 0.109530 | 36.89 |
| G10 | λ₁ | 0.217650 | 0.018130 | 8.33 |

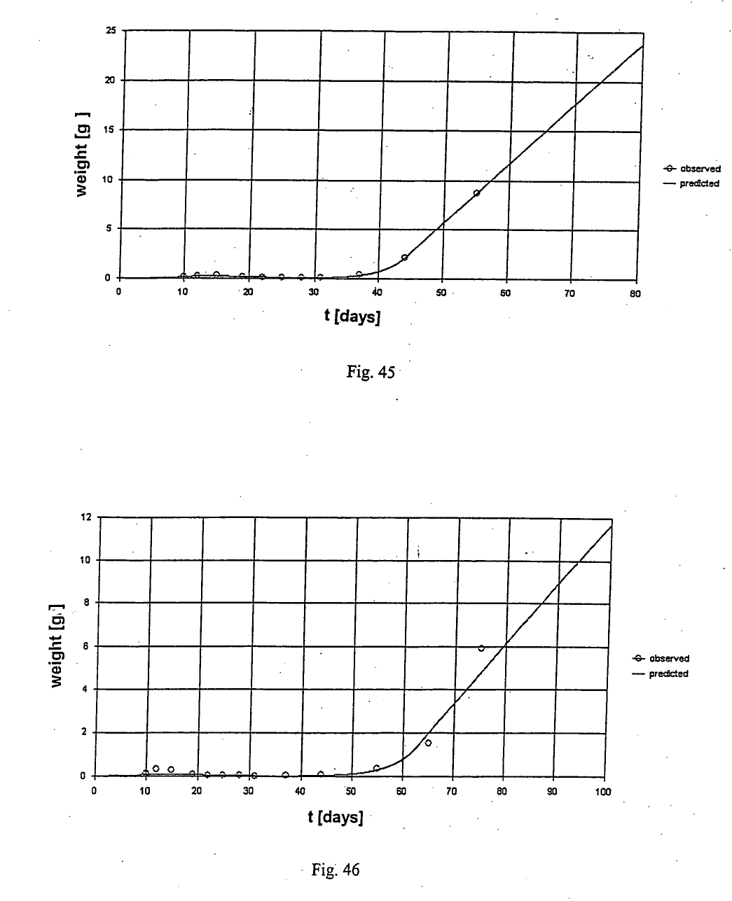

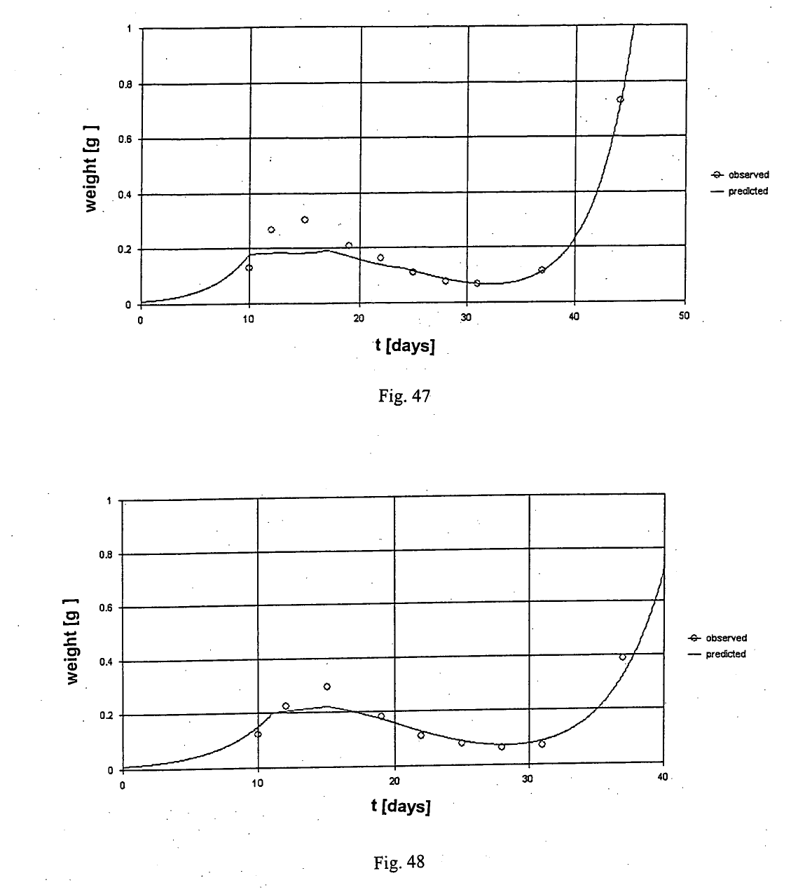

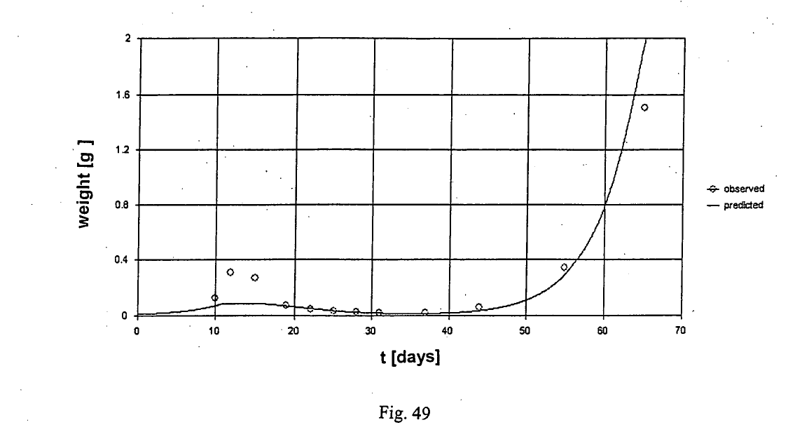

The observed and predicted values for three of the groups of the Experiment-C are graphically represented in FIGS. 45 and 46; to ascertain in a more effective way the difficulties encountered in the description of the phase of growth immediately after the first treatment, see the relative zooms in FIGS. 47-49.

The proposed model of tumor growth in the presence of a chemotherapeutic treatment provided good results in terms of fitting. The limited number of experimental observations imposed the use of a rather limited number of free parameters for not incurring in problems of model identification. Nevertheless, the bond of structural simplicity required for the model did not prevent from succeeding in describing the time course of the tumor weight in a realistic way, further succeeding in describing the main features underlined by the experimental data. At this regard, a remarkable correspondence between the predicted and observed values during the phase of re-growth of the tumor (delayed after the treatment) has to be noted.

As underlined during the fitting of the two experiments, the present invention allows to describe the experimental data in the short-long term while it is not able to adequately reproduce the time course of the tumor weight in the instants just after the first pharmaceutical treatment. A possible solution involves the use of a pure delay of time between the moment in which the tumor mass is damaged by the aggression of the drug and the instant in which the same one enters in the chain of mortality; the delay of time to be introduced (t_{lag}) allows the tumor mass to have a greater proliferating fraction, allowing a phase of growth even after the first administration. The introduction of the parameter t_{lag}, finds proven theoretical bases (Miklavèiè 1995, Minami 1998, Iliadis 2000) although a clear physiological interpretation did not result.

1. A method for estimating the anti-tumor activity of a compound administered to mammals developing a tumor, comprising:
a) measuring the tumor weight in time;
b) measuring the concentration of the compound in time;
c) calculating, on the basis of said measures, the following kinetic parameters of the tumor growth:
a parameter (L₀), representative of the portion of the tumor cells present at the instant t₀=0 that succeeds in taking root and in starting the tumor cells proliferation in the mammals;
an index (λₒ) of the production rate of the tumor cells during an exponential phase of the tumor growth;
an index (λ₁) of the tumor cells mass produced in the time unit during a linear phase of the tumor growth;
and the following pharmacodynamic parameters of the compound:
an index (K₁) of the tumor cells death rate;
an index (K₂) of the potency of the compound; and
d) calculating, on the basis of said kinetic and pharmacodynamic parameters, tumor growth curves.

2. A method according to claim 1, wherein a parameter (ψ), representative of the tumor growth curves shape, is calculated.

3. A method according to claim 1 or 2, wherein the parameters L₀, λₒ, λ₁, K₁ and K₂ are calculated using a non-linear fitting program, which finds the best combination of the parameters, comparing -in time- the measured tumor weights with the tumor weights calculated by the program, by the following system of ordinary differential equations and initial conditions:
$$\begin{matrix}\begin{matrix}{\dot{Z}}_{1} = \frac{{λ}_{0} \cdot {Z}_{1} ( t )}{{[ 1 + {( \frac{{λ}_{0}}{{λ}_{1}} \cdot W ( t ) )}^{ψ} ]}^{\frac{1}{ψ}}} - {K}_{2} \cdot c ( t ) \cdot {Z}_{1} ( t ) & {Z}_{1} ( 0 ) = {L}_{0}\end{matrix} & ( 6.8 ) \\ \begin{matrix}{\dot{Z}}_{2} ( t ) = {K}_{2} \cdot c ( t ) \cdot {Z}_{1} ( t ) - {K}_{1} \cdot {Z}_{2} ( t ) & {Z}_{2} ( 0 ) = 0\end{matrix} & ( 6.9 ) \\ … & \\ \begin{matrix}\dot{Z} i ( t ) = {K}_{1} \cdot {Z}_{i - 1} \cdot {Z}_{i - 1} ( t ) - {K}_{1} \cdot {Z}_{n} ( t ) & {Z}_{n} ( 0 ) = 0\end{matrix} & ( 6.11 )\end{matrix}$$
wherein
L₀, λₒ, λ₁, K₁, K₂ and Ψ are as defined in the previous claims;
Z₁(t), 1 being the state of the cells in the growing phase, is a function of the tumor mass damageable by the compound at the time (t);
Zᵢ(t) is a state variable, i-ranging from 2 to n-, representing damaged tumor cells that transit through n-1 compartments which represent the different tumor cells state and which form a chain of mortality;
c(t) is a function representing the compound concentration in time;
the calculated tumor weight W(t), representing both the set of the tumor cells not damaged by the compound pharmacological action and the set of the tumor cells in transit inside the chain of mortality, being
$$W ( t ) = {\sum }_{i = 1}^{n} {Z}_{i} ( t ) \qquad ( 6.6 )$$
wherein Zᵢ(t), i and t are as above defined.

4. A method according to the previous claim, wherein the survival time (τ) of damaged tumor cells in transit inside the chain of mortality is described through a random variable τ, for which a probability density function pdf(τ) is considered; said pdf(τ) being described, by applying a compartmental model comprising n-1 compartments, as defined in the previous claim, with first-order kinetics, regulated by K₁ and Zᵢ(t) as defined in the previous claims; said compartmental model being described by the following system of differential equations:
\dot{Z}₂(t)=K₂·c(t)·Z₁(t)−K₁·Z₂(t)
\dot{Z}₃(t)=K₁·Z₂(t)−K₁·Z₃(t) (6.2)
\dot{Z}ᵢ(t)=K₁·Zᵢ₋₁(t)−K₁·Zₙ(t)
wherein Zᵢ(t), i, t, n, K₁ and K₂ are as defined in the previous claims; under the hypothesis that the tumor mass in exit in the time unit from a compartment is proportional to the resident mass according to K₁ and considering that the growth of Z₁(t) is
\dot{Z}₁(t)=f(W(t))−K₂·c(t)·Z₁(t) (6.1)
wherein f(W(t)) represents the equation of the tumor growth of the mammals to which the compound has not been administered, function of the tumor total weight W(t).

5. A method according to claim 4, wherein the probability density function pdf(τ) has a bell-like shape.

6. A method according to claim 4 or 5, wherein the probability density function pdf(τ) of the random variable τ is an Erlang(n-1, K₁):
$$pdf ( τ ) = \begin{matrix}{K}_{1} \cdot exp ( - {K}_{1} \cdot t ) \cdot \frac{{( {K}_{1} \cdot t )}^{n - 2}}{( n - 2 ) !} & t = 0 \\ 0 & otherwise\end{matrix} \qquad ( 6.4 )$$
wherein K₁, t and n are as defined in the previous claims;
the mean value E[τ] and variance Var[τ] of the random variable τ resulting, respectively, from:
$$\begin{matrix}E [ τ ] = \frac{n - 1}{{K}_{1}} & ( 6.5 ) \\ Var [ τ ] = \frac{n - 1}{{K}_{1}^{2}} & ( 6.13 )\end{matrix}$$
wherein K₁ and n are as defined in the previous claims;
the related function of cumulative probability distribution resulting from:
$$F ( t ) = P ( τ \leq t ) = \{ \begin{matrix}1 - {\sum }_{j = 0}^{n - 2} exp ( - {K}_{1} t ) \frac{{( {K}_{1} t )}^{j}}{j !} & t \geq 0 \\ 0 & otherwise\end{matrix} \qquad ( 6.14 )$$
wherein F(t) represents the probability that the survival time τ of a damaged cell is less than a specified time t and K₁, j (ranging from 0 to n-2), t and n are as above defined.

7. A method according to any of the previous claims, wherein the tumor growth curves are determined by the program represented by the following system of ordinary differential equations and initial conditions:
$${\dot{Z}}_{1} = \frac{{λ}_{0} \cdot {Z}_{1} ( t )}{{[ 1 + {( \frac{{λ}_{0}}{{λ}_{1}} \cdot W ( t ) )}^{ψ} ]}^{\frac{1}{ψ}}} - {K}_{2} \cdot c ( t ) \cdot {Z}_{1} ( t ) {Z}_{1} ( 0 ) = {L}_{0} \qquad ( 6.8 )$$
\dot{Z}₂(t)=K₂·c(t)·Z₁(t)−K₁·Z₂(t) Z₂(0)=0 (6.9)
\dot{Z}₃(t)=K₁·Z₂(t)−K₁·Z₃(t) Z₃(0)=0 (6.10)
\dot{Z}₄(t)=K₁·Z₃(t)−K₁·Z₄(t) Z₄(0)=0 (6.11′)
wherein:
Z₂(t) to Z₄(t) are state variables representing damaged tumor cells that transit through the compartments 2, 3 and 4, respectively, forming the chain of mortality; and
K₁, K₂, λₒ, λ₁, c(t), L₀, ψ and Z₁(t) are as defined in the previous claims;
the function W(t) of the tumor weight in time resulting from
W(t)=Z₁(t)+Z₂(t)+Z₃(t)+Z₄(t) (6.12)
wherein W(t) is a function of the tumor weight in time and Z₁(t) to Z₄(t) are as above defined.

8. A method according to any of the previous claims, wherein Ψ is fixed to 20.

9. A method according to any of claims 3 to 8, wherein the best combination of the parameters is carried out by the technique of the weighed least squares.

10. A method according to any of claims 3 to 9, wherein the tumor measurement error is determined by the following measurement error model:
D_{MIN}=D\hat{ }_{MIN}+ε_{MIN} (3.3)
D_{MAX}=D\hat{ }_{MAX}+ε_{MAX} (3.4)
wherein D_{MIN} and D_{MAX} represent the real smallest and largest diameters of the tumor mass, respectively; D\hat{ }_{MIN} and D\hat{ }_{MAX} represent the experimental values of D_{MIN} and D_{MAX} and ε_{MIN} and ε_{MAX} represent the measurement errors, for which it is assumed that:
Var[ε_{MIN}]=CV^{2·}D²_{MIN} (3.5)
Var[ε_{MAX}]=CV^{2·}D²_{MAX} (3.6)
wherein CV is a constant representing the coefficient of variation and Var is the variance, asssuming the presence of an error of additive type proportional to the real value of the diameters.

11. A method according to the previous claim, wherein approximating D_{MIN}≅D_{MAX}, the variance of the tumor weight is:
Var[Ŵ]≅ξ²·W² (3.8)
wherein W is the experimental value of W and ξ is a proportionality factor to CV.

12. A method according to any of the previous claims, wherein the calculation of the tumor growth curves comprises a delay of time (t_{lag}) between the moment in which the tumor mass is damaged by the aggression of the compound and the instant in which the mass enters the chain of mortality.

13. A method according to the previous claim, wherein the delay consists in inserting a delay in the time of administration of the compound to the mammals.

14. A method according to any of the previous claims, wherein the kinetic parameters K₁ and K₂ are either directly measured or derived from known estimates of the same tumor cell line on the same mammals obtained by previous experiments.

15. A method for predicting the anti-tumor activity of a compound administered to mammals developing a tumor, comprising:
a) measuring the concentration of the compound in time;
b) assigning values to the parameters L₀, λₒ, λ₁, K₁, K₂, and ψ, said parameters being defined as in claim 1 and 2, considering that L₀ is an estimate of the portion of the tumor cells present at the instant t₀=0 that succeeds in taking root and in starting the tumor cells proliferation in the mammals; λₒ is an estimate of the production rate of the tumor cells during an exponential phase of the tumor growth; λ₁ is an estimate of the tumor cells mass produced in the time unit during a linear phase of the tumor growth; K₁ is an estimate of (n-1)/Eτ], where E[τ]is the expected value of the, survival time r of a damaged tumor cell; K₂ is an estimate of λₒT/AUC, where AUC is the area under the curve of the concentration of the compound in a given mammal and T is the time delay between the linear phase of the tumor growth in that given mammal and the tumor growth curve of the mammals to which the compound has not been administered; and
c) calculating, on the basis of said measure and of the parameters assigned values, tumor growth curves.

16. A method according to the previous claim, wherein ψ is fixed to 20.

17. A method according to claim 15 or 16, wherein the tumor growth curves are calculated using a program which predicts the tumor weight by the following system of ordinary differential equations and initial conditions:
$${\dot{Z}}_{1} = \frac{{λ}_{0} \cdot {Z}_{1} ( t )}{{[ 1 + {( \frac{{λ}_{0}}{{λ}_{1}} \cdot W ( t ) )}^{ψ} ]}^{\frac{1}{ψ}}} - {K}_{2} \cdot c ( t ) \cdot {Z}_{1} ( t ) {Z}_{1} ( 0 ) = {L}_{0} \qquad ( 6.8 )$$
\dot{Z}₂(t)=K₂·c(t)·Z₁(t)−K₁·Z₂(t) Z₂(0)=0 (6.9)
\dot{Z}i(t)=K₁·Zᵢ₋₁(t)−K₁19 Zₙ(t) Zₙ(0)=0 (6.11)
wherein
L₀, λₒ, λ₁, K₁, K₂, Ψ, Z₁(t) to Zi(t), i, t, n and c(t) are as defined in the previous claims;
the calculated tumor weight W(t), representing both the set of the tumor cells not damaged by the compound pharmacological action and the set of the tumor cells in transit inside the chain of mortality, being
$$W ( t ) = {\sum }_{i = 1}^{n} {Z}_{i} ( t ) \qquad ( 6.6 )$$
wherein Zᵢ(t), i, t and n are as above defined.

18. A method according to the previous claim, wherein the survival time (τ) of damaged tumor cells in transit inside the chain of mortality is described through a random variable τ for which a probability density function pdf(τ) is considered; said pdf(τ) being described, by applying a compartmental model comprising n-1 compartments, as defined in the previous claim, with first-order kinetics, regulated by K₁ and Zᵢ(t) as defined in the previous claim; said compartmental model being described by the following system of differential equations:
\dot{Z}₂(t)=K₂·c(t)·Z₁(t)−K₁·Z₂(t)
\dot{Z}₃(t)=K₁·Z₂(t)−K₁·Z₃(t) (6.2)
\dot{Z}ᵢ(t)=K₁·Zᵢ₋₁(t)−K₁·Zₙ(t)
wherein Zᵢ(t), i, t, n, K₁ and K₂ are as defined in the previous claim; under the hypothesis that the tumor mass in exit in the time unit from a compartment is proportional to the resident mass according to K₁ and considering that the growth of Z₁(t) is
\dot{Z}₁(t)=f(W(t))−K₂·c(t)·Z₁(t) (6.1)
wherein f(W(t)) represents the equation of the tumor growth of the mammals to which the compound has not been administered, function of the tumor total weight W(t).

19. A method according to the previous claim, wherein the probability density function pdf(τ) has a bell-like shape.

20. A method according to claim 18 or 19, wherein the probability density function pdf(τ) of the random variable X is an Erlang (n-1, K₁):
$$pdf ( τ ) = \begin{matrix}{K}_{1} \cdot exp ( - {K}_{1} \cdot t ) \cdot \frac{{( {K}_{1} \cdot t )}^{n - 2}}{( n - 2 ) !} & t = 0 \\ 0 & otherwise\end{matrix} \qquad ( 6.4 )$$
wherein K₁, t and n are as defined in the previous claims;
the mean value E[τ] and variance Var[τ] of the random variable τ resulting, respectively, from:
$$\begin{matrix}\frac{n - 1}{{K}_{1}} & ( 6.5 ) \\ Var [ τ ] = \frac{n - 1}{{K}_{1}^{2}} & ( 6.13 )\end{matrix}$$
wherein K₁ and n are as defined in the previous claims;
the related function of cumulative probability distribution resulting from:
$$F ( t ) = P ( τ \leq t ) = \{ \begin{matrix}1 - {\sum }_{j = 0}^{n - 2} exp ( - {K}_{1} t ) \frac{{( {K}_{1} t )}^{j}}{j !} & t \geq 0 \\ 0 & otherwise\end{matrix} \qquad ( 6.14 )$$
wherein F(t) represents the probability that the survival time τ of a damaged cell is less than a specified time t and K₁, j (ranging from 0 to n-2), t and n are as above defined.

21. A method according to any of the claims 15 to 20, wherein the tumor growth curves are calculated using a program which predicts the tumor weight by the following system of ordinary differential equations and initial conditions:
$${\dot{Z}}_{1} = \frac{{λ}_{0} \cdot {Z}_{1} ( t )}{{[ 1 + {( \frac{{λ}_{0}}{{λ}_{1}} \cdot W ( t ) )}^{ψ} ]}^{\frac{1}{ψ}}} - {K}_{2} \cdot c ( t ) \cdot {Z}_{1} ( t ) {Z}_{1} ( 0 ) = {L}_{0} \qquad ( 6.8 )$$
\dot{Z}₂(t)=K₂·c(t)·Z₁(t)−K₁·Z₂(t) Z₂(0)=0 (6.9)
\dot{Z}₃(t)=K₁·Z₂(t)−K₁·Z₃(t) Z₃(0)=0 (6.10)
\dot{Z}₄(t)=K₁·Z₃(t)−K₁·Z₄(t) Z₄(0)=0 (6.11′)
wherein:
K₁, K₂, λₒ, λ₁, c(t), L₀, ψ and Z₁(t) to Z₄(t) are as defined in claims 14 to 19;
the function [W(t)] of the tumor weight in time resulting from
W(t)=Z₁(t)+Z₂(t)+Z₃(t)+Z₄(t) (6.12)
wherein W(t) is a function of the tumor weight in time and Z₁(t) to Z₄(t) are as above defined.

22. A method according to any of the previous claims, wherein the compound is an antitumor agent.

23. A method according to any of the previous claims, wherein the compound is paclitaxel or brostallicin.

24. A method according to any of the previous claims, wherein the concentration of the compound is either directly measured or indirectly determined from pharmacokinetics models of interspecies scaling.

25. A method according to any of the previous claims, wherein the concentration of the compound is measured in plasma, serum or tissue.

26. A method for estimating the tumor growth in mammals developing a tumor, comprising:
a) measuring the tumor weight in time;
b) calculating, on the basis of said measures, the parameters L₀, λₒ, λ₁, said parameters being defined as in claim 1;
c) calculating, on the basis of said parameters, tumor growth curves.

27. A method according to the previous claim, wherein the parameter ψ, as defined as in claim 2, is calculated.

28. A method according to the previous claim, wherein ψ is fixed to 20.

29. A method according to any of claims 26 to 28, wherein the tumor growth is calculated by a statistical program and defined by the following function:
$$\dot{W} = \frac{{λ}_{0} \cdot W \text{?}}{[ 1 + ( \frac{{λ}_{0}}{{λ}_{1}} \cdot W \text{?}} W ( 0 ) = {L}_{0} \\ \text{?} \text{indicates text missing or illegible when filed} \qquad ( 5.13 )$$
wherein:
W(t), t, λₒ, λ₁ and Ψ are as defined in the previous claims.

30. A method according to any of claims 26 to 29, wherein the tumor measurement error is determined by the measurement error model of claim 10.

31. A method according to the previous claim, wherein approximating D_{MIN}≅D_{MAX}, the tumor weight variance is as defined in claim 11.

32. A method for predicting the tumor growth in mammals developing a tumor, comprising:
a) assigning values to the parameters L₀, λₒ, λ₁ and ψ, said parameters being defined as in claim 1 and 2, considering that L₀ is an estimate of the portion of the tumor cells present at the instant t₀=0 that succeeds in taking root and in starting the tumor cells proliferation in the mammals; λₒ is an estimate of the production rate of the tumor cells during an exponential phase of the tumor growth; λ₁ is an estimate of the tumor cells mass produced in the time unit during a linear phase of the tumor growth; and
b) calculating, on the basis of the parameters assigned values, tumor growth curves.

33. A method according to the previous claim, wherein v is fixed to 20.

34. A method according to claim 32 or 33, wherein the tumor growth is calculated by a statistical program and defined by the following function:
$$\dot{W} = \frac{{λ}_{0} \cdot W ( t \text{?}}{[ 1 + ( \frac{{λ}_{0}}{{λ}_{1}} \cdot W ( t \text{?}} W ( 0 ) = {L}_{0} \\ \text{?} \text{indicates text missing or illegible when filed} \qquad ( 5.13 )$$
wherein:
W(t), t, L₀, λₒ, λ₁ and Ψ are as defined in the previous claims.

35. A method according to any of the previous claims, wherein the non-linear fitting or statistical program is WinNonLin® 3.1.

36. A method according to any of claims 1 to 25, for evaluating the mechanism of action of a compound administered to mammals developing a tumor.

37. A method according to the previous claim, wherein the tumor growth curves are calculated using a program which predicts the tumor weight by the following system of ordinary differential equations and initial conditions:
$$\begin{matrix}{\dot{Z}}_{1} = \frac{{λ}_{0} \cdot {Z}_{1} ( t )}{{[ 1 + {( \frac{{λ}_{0}}{{λ}_{1}} \cdot W ( t ) )}^{ψ} ]}^{\frac{1}{ψ}}} - {K}_{2} \cdot c ( t ) \cdot {Z}_{1} ( t ) + {\sum }_{i = 2}^{n} {γ}_{i} {Z}_{i} ( t ) & {Z}_{1} ( 0 ) = {L}_{0} \\ {\dot{Z}}_{2} ( t ) = {K}_{2} \cdot c ( t ) \cdot {Z}_{1} ( t ) - ( {K}_{1} + {γ}_{2} ) \cdot {Z}_{2} ( t ) & {Z}_{2} ( 0 ) = 0 \\ … & \\ \dot{Z} i ( t ) = {K}_{1} \cdot {Z}_{i - 1} ( t ) - ( {K}_{1} + {γ}_{n} ) \cdot {Z}_{n} ( t ) & {Z}_{n} ( 0 ) = 0\end{matrix}$$
wherein γᵢ is an index, possibly equal to zero, of the rate of tumor cells in the i-th compartment that recover from their damage, while L₀, λₒ, λ₁, K₁, K₂, Ψ, Z₁(t), Zᵢ(t), i, n, t and c(t) are as defined in the previous claims; the calculated tumor weight W(t) being
$$W ( t ) = {\sum }_{i = 1}^{n} {Z}_{i} ( t ) \qquad ( 6.6 )$$
wherein Zᵢ(t), i, n and t are as defined in the previous claims.

38. A method according to any of claims 1 to 25, for estimating a minimal steady state compound concentration to be maintained for observing tumor regression in in vivo experiments.

39. A method according to any of claims 1 to 25, for testing the additivity of the effect of at least two compounds on the tumor growth in in vivo experiments.

40. A method according to the previous claim, wherein the tumor growth curves are calculated using a program which predicts the tumor weight by the following system of ordinary differential equations and initial conditions:
$$\begin{matrix}{\dot{Z}}_{1} = \frac{{λ}_{0} \cdot {Z}_{1} ( t )}{{[ 1 + {( \frac{{λ}_{0}}{{λ}_{1}} \cdot W ( t ) )}^{ψ} ]}^{\frac{1}{ψ}}} - {Z}_{1} ( t ) + {\sum }_{j = 1}^{d} {K}_{2 j} \cdot {c}_{j} ( t ) & {Z}_{1} ( 0 ) = {L}_{0} \\ {\dot{Z}}_{2 j} ( t ) = {Z}_{1} ( t ) {K}_{2 j} \cdot {c}_{j} ( t ) - {K}_{1 j} \cdot {Z}_{2 j} ( t ) & {Z}_{2 j} ( 0 ) = 0 \\ … & \\ {\dot{Z}}_{ij} ( t ) = {K}_{1 j} \cdot {Z}_{i - 1 j} ( t ) - {K}_{1 j} \cdot {Z}_{ij} ( t ) & {Z}_{ij} ( 0 ) = 0\end{matrix}$$
wherein:
L₀, λₒ, λ₁, K₁, Ψ, Z₁(t), Zᵢ(t), i, n, and t are as above defined; K₁ⱼ is an index of the tumor cells death rate of the j-th compound; K₂ⱼ is and index of the potency of the j-th compound; Zᵢⱼ(t) is a state variable, i-ranging from 2 to n- and j ranging 1 to d (d being the number of the compounds), representing damaged tumor cells that transit through n-1 compartments, which represent the different tumor cells state and which form a chain of mortality regulated by K₁ⱼ of the j-th compound; and cⱼ(t) is a function representing the concentration of the j-th compound;
the calculated tumor weight W(t) being
$$W ( t ) = {Z}_{1} ( t ) + {\sum }_{j = 1}^{d} {\sum }_{i = 2}^{n} {Z}_{ij} ( t ) \qquad ( 6.6 ' )$$
wherein Zᵢⱼ(t), i, j, d, n and t are as above defined.

41. A method according to any of the previous claims comprising a statistical program simultaneously fitting tumor growth curves of individual values or of the mean values for implementing the methods according to any of the previous claims.

42. A method according to the previous claim, wherein the statistical program is NONMEM.

43. A method according to any of the previous claims, wherein the mammals are nude mice.

44. A method according to any of the previous claims, wherein the mammals are subcutaneously inoculated with tumor cells so to develop a tumor.

45. A computer program for estimating or predicting the anti-tumor activity of a compound administered to mammals developing a tumor, or for estimating or predicting the tumor growth in said mammals comprising computer code means for implementing the methods according to any of the previous claims.

46. Use of the calculation of the tumor growth curves according to any of claims 1 to 25, for predicting the optimal administration dosage/schedule of a compound for the preparation of a medicament for the treatment of tumor.
